(19) United States
(12) Patent Application Publication
(10) Pub. No.: US 2012/0281544 A1
(43) Pub. Date: Nov. 8, 2012

(54) Mobility For Multipoint Operations

(75) Inventors: Bhaskar M. Anepu, Hummelstown, PA (US); Sylvie Gomes, Douglaston, NY (US); Diana Pani, Montreal (CA); Lujing Cai, Morganville, NJ (US)

(73) Assignee: InterDigital Patent Holdings, Inc., Wilmington, DE (US)

(21) Appl. No.: 13/289,607

(22) Filed: Nov. 4, 2011

Related U.S. Application Data
(60) Provisional application No. 61/410,567, filed on Nov. 5, 2010.
(60) Provisional application No. 61/430,736, filed on Jan. 7, 2011.

(51) Int. Cl. H04W 4/00; H04W 24/10

(52) U.S. Cl. 370/241; 370/328

(57) ABSTRACT

Systems and methods are provided for receiving data from multiple cells. A wireless transmit and receive unit (WTRU) may receive data from cells in a multi-point set that includes a primary serving cell and one or more assisting serving cells. The WTRU measures the quality of cells in the multipoint set as well as neighboring cells. Based on the cell quality, the WTRU triggers a reporting event, such cell adding event, cell removal event, or cell replacement event, and sends a measurement report to the network. The WTRU receives an indication of a change to the multi-point set from the network, and modifies the multi-point set accordingly.

### CROSS-REFERENCE TO RELATED APPLICATIONS

This application claims the benefit of U.S. Provisional Application No. 61/410,567, filed Nov. 5, 2010, and U.S. Provisional Application No. 61/430,736, filed Jan. 7, 2011, which are hereby incorporated by reference herein.

### BACKGROUND

In Release-7 of UMTS, the Single Cell Downlink Multiple-Input Multiple-Output (MIMO) (SC-MIMO) feature was introduced. This feature allows a NodeB to transmit two transport blocks to a single user equipment (UE) from the same sector on a pair of transmit antennas thus improving data rates at high geometries and providing a beamforming advantage to the UE in low geometry conditions. In Release-8 and Release-9 of UMTS, the Dual Cell High Speed Packet Access (DC-HSDPA) and Dual Band DC-HSDPA features were subsequently introduced. Both these features allow the NodeB to serve one or more users by simultaneous operation of HSDPA on two different frequency channels in the same sector, thus improving the user experience across the entire cell.

Two or more independent transport blocks may be transmitted to the UE. The transport blocks may be transmitted from different non-overlapping NodeB sectors on a single frequency or on multiple frequencies, addressed as multipoint HSDPA (MP-HSDPA) or multi-flow (MF-HSDPA) or Coordinated Multi-Point (CoMP). The reception of data over multiple cells from overlapping or non-overlapping can take place over one frequency or over different frequencies. This mode of operation can be referred to as single frequency dual cell (SF-DC) or multiple cell HSDPA, multi-point HSDPA, multi-point reception or CoMP, co-operative multipoint. These terms may be used interchangeably.

In multi-point operation, a UE that is capable of dual cell or multi-cell reception may receive two or more High-Speed Downlink Shared Channels (HS-DSCH), transport blocks or data from two or more different cells operating on the same frequency or different frequencies. Unfortunately, current technologies cannot efficiently perform mobility and cell management for multi-point operations.

### SUMMARY

It is desirable to implement a mobility and cell management mechanism that may handle the existence of two or more serving cells on the same frequency or different frequencies, configure UE with multiple serving cells in the same frequency or different frequency on potentially non-overlapping cells simultaneously, and allow simultaneous change of the primary serving cell and the assisting cell(s) to occur.

Systems and methods are provided for receiving data from multiple cells. For example, a wireless transmit and receive unit (WTRU) may receive data from cells in a multi-point set. The multipoint set may include a primary serving cell and one or more assisting serving cells. The WTRU may measure the quality of cells in the multipoint set as well as neighboring cells or non-assisting cells. Based on the cell quality, the WTRU may trigger a reporting event, such cell adding event, cell removal event, or cell replacement event. The WTRU may send a measurement report to the network, reporting the triggered event and the cell quality. Based on the report, the network may determine to change the multi-point set for the WTRU.

In an embodiment, if the cell quality of a non-assisting cell exceeds the cell quality of an assisting serving cell by a predetermined threshold for a predetermined period of time, the non-assisting cell may replace the assisting serving cell in the multi-point set. The WTRU may receive an indication of the change to the multi-point set from the network. The WTRU may modify the multi-point set in accordance with the indication. For example, the WTRU may stop receiving data from the current assisting serving cell, and start receiving data from the cell that replaces the current assisting serving cell in the multi-point set.

In an embodiment, the WTRU may be pre-configured with a list of target cells. For example, the WTRU may receive and store pre-configuration information associated with the cell in a target cell list. The pre-configuration information may include connection parameters associated with each of the cells in the target cell list. The WTRU may receive an order from the network to dynamically activate or deactivate a target cell. For example, when a target cell is activated, the WTRU may connect to the activated target cell using the pre-configuration information associated with the target cell. The WTRU may monitor the downlink of the activated target cell, and may start receiving data from the activated target cell.

The Summary is provided to introduce a selection of concepts in a simplified form that are further described below in the Detailed Description. This Summary is not intended to identify key features or essential features of the claimed subject matter, not is it intended to be used to limit the scope of the claimed subject matter. Furthermore, the claimed subject matter is not limited to any limitations that solve any or all disadvantages noted in any part of this disclosure.

### BRIEF DESCRIPTION OF THE DRAWINGS

A more detailed understanding may be had from the following description, given by way of example in conjunction with the accompanying drawings.

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a system diagram of an example radio access network and an example core network that may be used within the communications system illustrated in FIG. 1A.

FIG. 1E is a system diagram of an example radio access network and an example core network that may be used within the communications system illustrated in FIG. 1A.

FIG. 2 illustrates a diagram of adding a cell to a multi-point set according to an embodiment.

FIG. 3 illustrates a diagram of example multi-point set operations.

FIG. 4 illustrates a diagram of a synchronized radio link reconfiguration prepare procedure.

FIG. 5 illustrates an example process for managing a multi-point set.

FIGS. 6 and 7 illustrate example processes for receiving data from multiple serving cells.

FIGS. 8 and 9 illustrate example processes for maintaining a target cell list.

### DETAILED DESCRIPTION

System embodiments and method embodiments for single frequency dual cell mobility are disclosed herein. The following sections provide a description of these various embodiments.

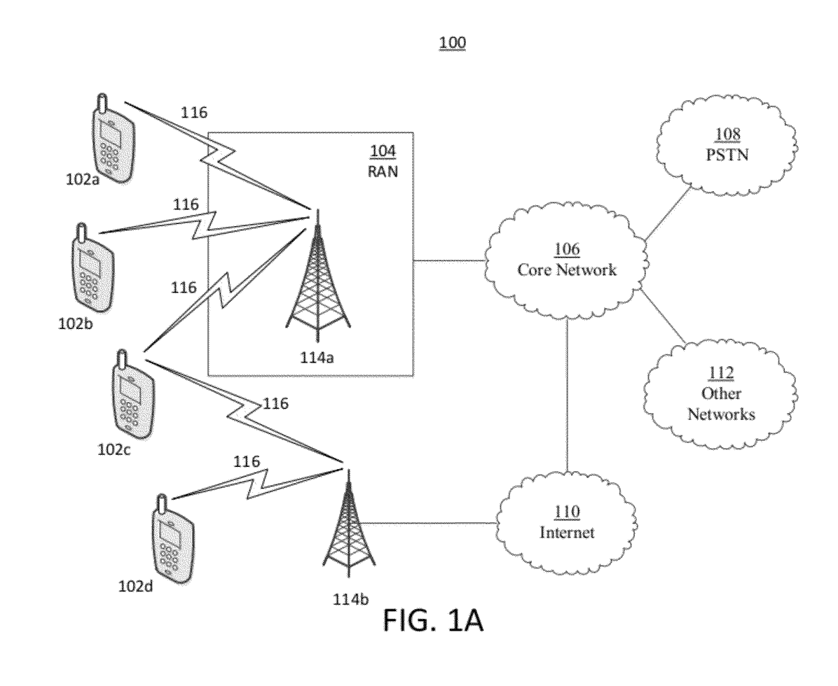

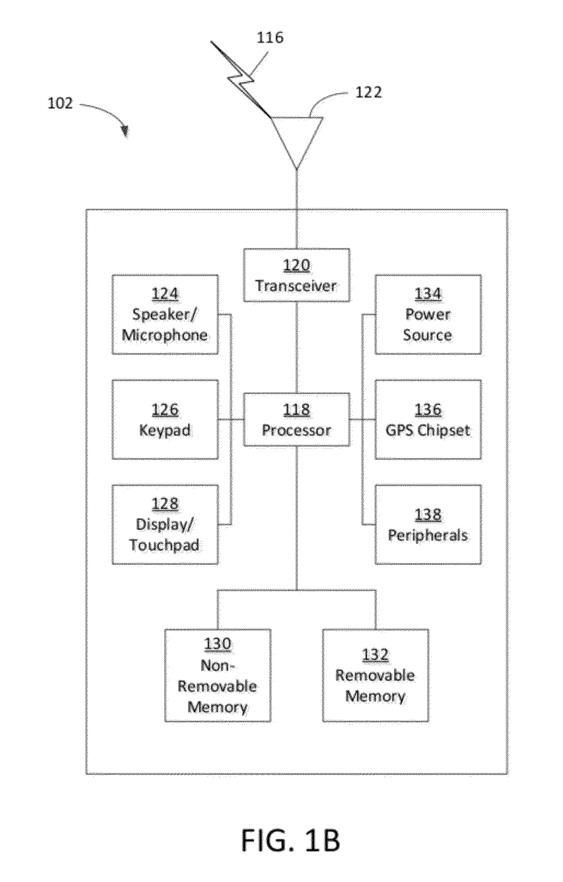

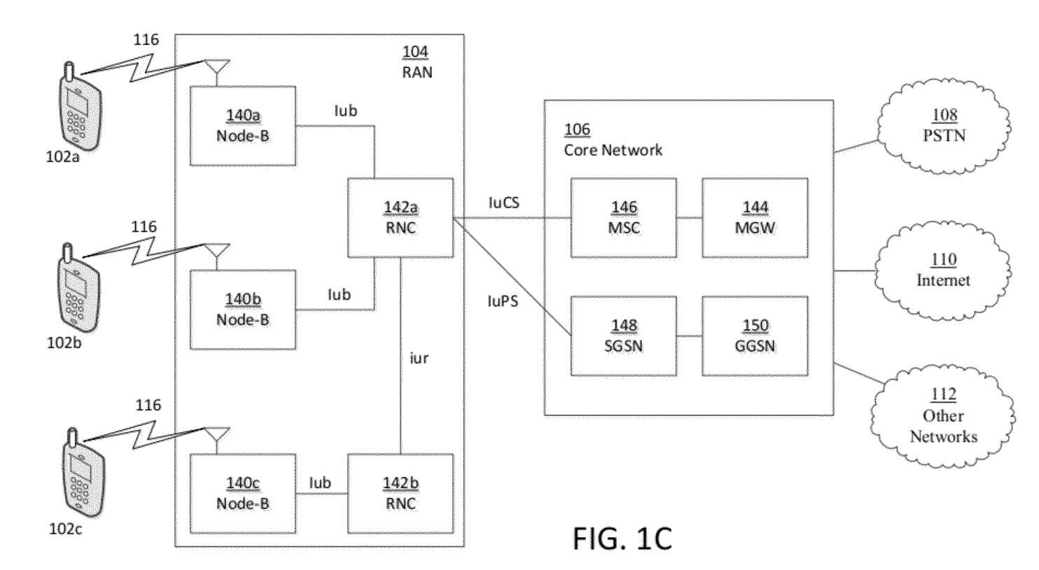

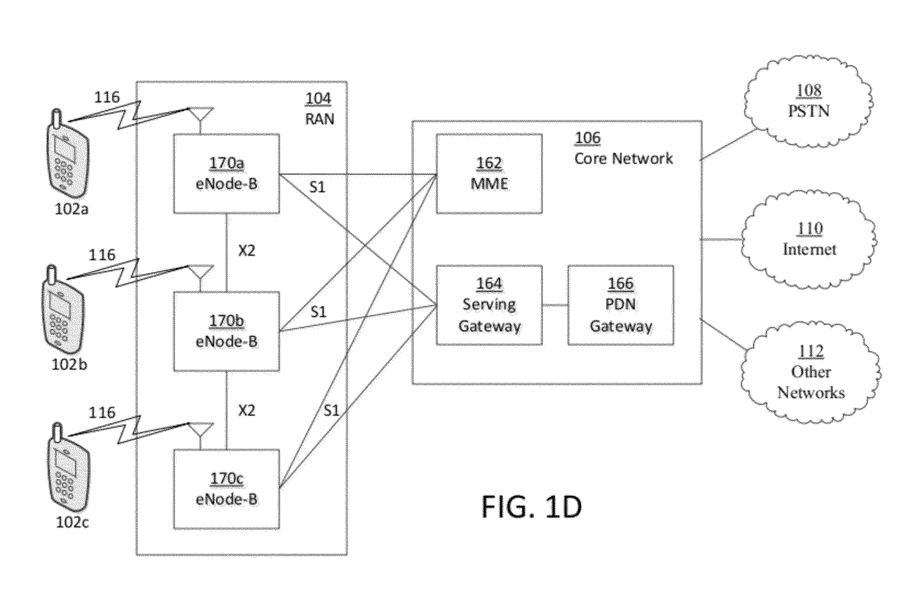

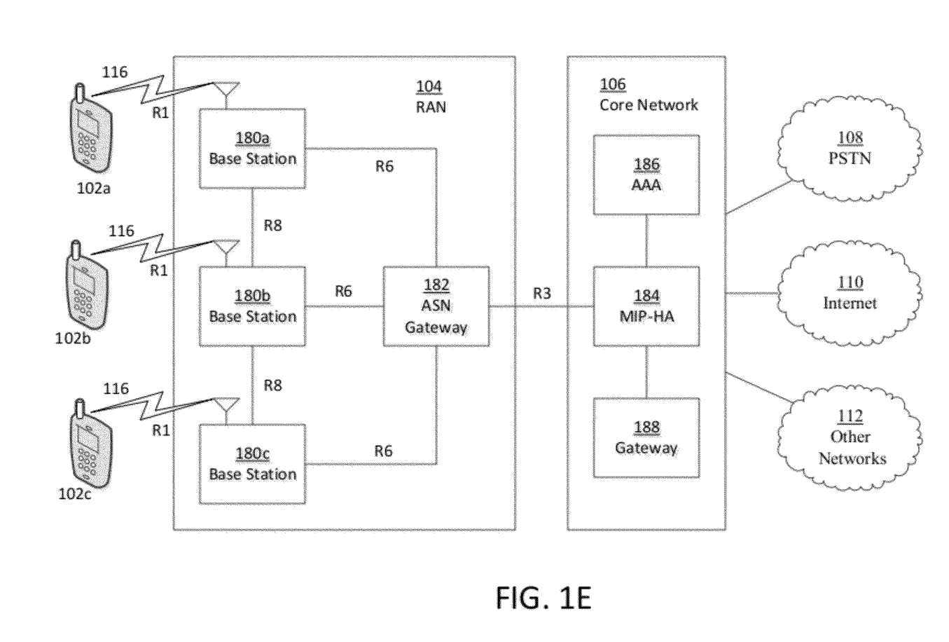

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in an embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1x, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In an embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The core network 106 may include at least one transceiver and at least one processor. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ a UTRA radio technology to communicate with the WTRUs 102a, 102b and 102c over the air interface 116. The RAN 104 may also be in communication with the core network 106. As shown in FIG. 1C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 170a, 170b, 170c, though it will be appreciated that the RAN 104 may include any number of eNode-Bs while remaining consistent with an embodiment. The eNode-Bs 170a, 170b, 170c may each include one or more transceivers for communicating with the WTRUs 102a, 102b, 102c over the air interface 116. In an embodiment, the eNode-Bs 170a, 170b, 170c may implement MIMO technology. Thus, the eNode-B 140a, for example, may use multiple antennas to transmit wireless signals to, and receive wireless signals from, the WTRU 102a.

Each of the eNode-Bs 170a, 170b, 170c may be associated with a particular cell (not shown) and may be configured to handle radio resource management decisions, handover decisions, scheduling of users in the uplink and/or downlink, and the like. As shown in FIG. 1D, the eNode-Bs 170a, 170b, 170c may communicate with one another over an X2 interface.

The core network (CN) 106 shown in FIG. 1D may include a mobility management gateway (MME) 162, a serving gateway 164, and a packet data network (PDN) gateway 166. While each of the foregoing elements are depicted as part of the core network 106, it will be appreciated that any one of these elements may be owned and/or operated by an entity other than the core network operator.

The MME 162 may be connected to each of the eNode-Bs 170a, 170b, 170c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode Bs 170a, 170b, 170c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

FIG. 1E is a system diagram of the RAN 104 and the core network 106 according to an embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 1E, the RAN 104 may include base stations 180a, 180b, 180c, and an ASN gateway 142, though it will be appreciated that the RAN 104 may include any number of base stations and ASN gateways while remaining consistent with an embodiment. The base stations 180a, 180b, 180c may each be associated with a particular cell (not shown) in the RAN 104 and may each include one or more transceivers for communicating with the WTRUs 102a, 102b, 102c over the air interface 116. In one embodiment, the base stations 180a, 180b, 180c may implement MIMO technology. Thus, the base station 140a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 215 may be defined as an R6 reference point. The R6 reference point may include protocols for facilitating mobility management based on mobility events associated with each of the WTRUs 102a, 102b, 100c.

As shown in FIG. 1E, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 184, an authentication, authorization, accounting (AAA) server 186, and a gateway 188. While each of the foregoing elements are depicted as part of the core network 106, it will be appreciated that any one of these elements may be owned and/or operated by an entity other than the core network operator.

A WTRU may receive data from multiple serving cells. For example, the WTRU may receive data from a primary serving cell, and one or more assisting cells. A serving cell may correspond to a HS-DSCH serving cell, Enhanced Dedicated Channel (E-DCH) serving cell, and/or a primary serving cell (Pcell). These terms maybe used interchangeably throughout this document. A primary serving cell may include a cell associated with the primary cell as configured in the WTRU by the network. For example, the primary cell may correspond to the best cell in a frequency, such as a primary frequency as determined by the network. In an example HSPA system, a primary cell may correspond to the cell where the full Dedicated Channel (DCH), HS-DSCH, and E-DCH channels are transmitted. The channels may include, but not limited to, Fractional Dedicated Physical Channel (F-DPCH), Enhanced Access Grant Channel (E-AGCH), E-DCH Hybrid ARQ Indicator Channel (E-HICH), E-DCH Absolute Grant Channel (E-RGCH) or the like.

An assisting cell may correspond to an assisting serving cell, a secondary serving cell, a secondary cell (Scell), a multi-point cell, and/or a cooperating cell. These terms may be used interchangeably throughout this document. An assisting cell may include a secondary cell as configured by the network in the WTRU. An assisting cell may include a secondary cell or multi-point transmission cell that is not a primary serving cell. The network may configure the assisting cell. Assisting cells may correspond to non-overlapping secondary cells with respect to the primary serving cell in the same frequency or in a different frequency. An assisting serving cell may include a cell other than the best or primary cell that the WTRU may communicate to.

A multi-point cell may be a cell with same Physical Cell Identity (PCI) as the primary cell or with a different PCI. A cell may include a point. For example, in an example LTE system, a multipoint may be referred to as a cooperating cell or point.

An assisting cell may transmit a subset of the channels transmitted on a corresponding primary cell. For example, a High Speed Downlink Shared Channel (HS-DSCH) assisting cell may transmit High Speed Dedicated Physical Control Channel (HS-DPCCH), High Speed Shared Control Channel (HS-SCCH), and common pilot channel (CPICH). For multi-point transmission, the F-DPCH channel may be transmitted if the channel is in the WTRU's DCH active set. An assisting cell may include a secondary HS-DSCH serving cell, and/or a secondary E-DCH serving cell. These terms may be used interchangeably throughout this document.

The WTRU may receive data from the primary and assisting serving cell(s) simultaneously. The WTRU may receive data from one or a subset of the cells at a time.

The multiple serving cells that the WTRU receive data from may be referred to as a multi-point set. The multi-point set may include a primary serving cell and one or more assisting serving cell. In an embodiment, serving cells in the multi-point set may operate in the same frequency. For example, the primary serving cell may correspond to the best cell in the frequency. In an embodiment, the multi-point set may include serving cells that operate in different frequencies. The serving cells in the multi-point set may not overlap with one another.

The WTRU may receive data from multiple cells such as up to N cells within a reporting range or quality range, where N may correspond to the maximum allowed size of the multi-point set.

In an example HSPA system, a multi-point set for downlink HS-DSCH reception may include a HS-DSCH active set and/or a HS-DSCH multi-point set. Multi-point set, HS-DSCH active set and HS-DSCH multi-point set are used interchangeably herein. In an example LTE system, a multi-point set may include a CoMP set. Multi-point set and CoMP set are used interchangeably herein.

A multi-point set or HS-DSCH active set may be a subset of an active set. An active set may include a combination of HS-DSCH and/or E-DCH cells for multi-point transmissions. For multi-cell uplink (UL) operation, there may be an active set for each configured frequency. The HS-DSCH active set may correspond to a subset of the DCH active set of the WTRU.

A primary frequency may include the frequency associated with the primary serving cell and/or the primary HS-DSCH radio link. A secondary frequency may include the frequency associated with a secondary cell or assisting cell. The secondary frequency may be associated with the assisting HS-DSCH radio link in a frequency different than the primary serving cell.

A secondary serving NodeB may include a NodeB that may control an assisting cell. The secondary NodeB may be referred to as an assisting NodeB. In an embodiment, an assisting cell may be configured at a secondary serving NodeB. In an embodiment, a primary serving cell may not be configured at a secondary serving NodeB.

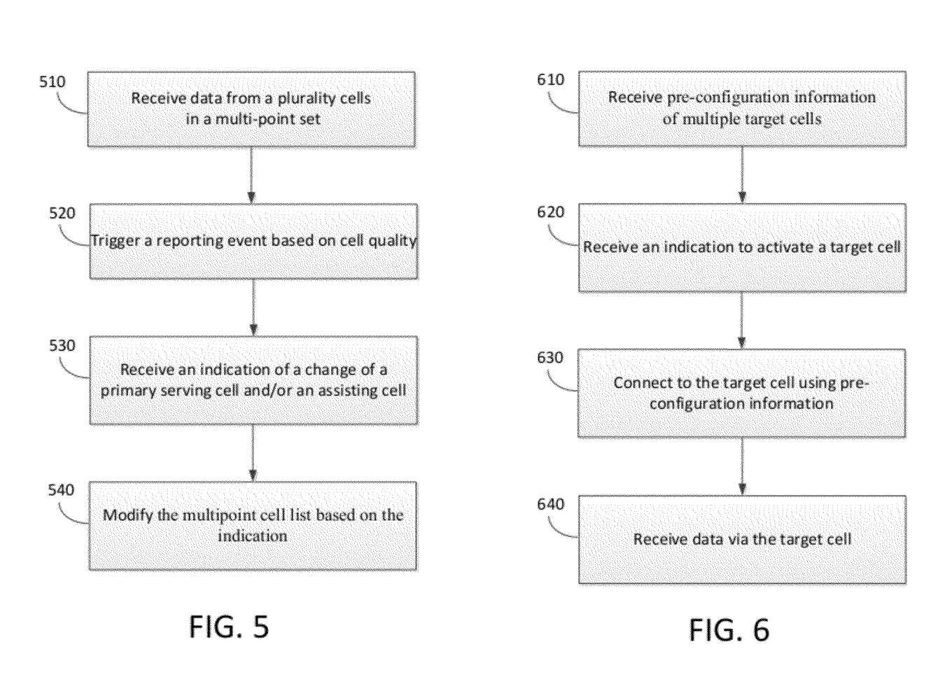

FIG. 5 illustrates an example process for managing a multi-point set to allow for receiving data via multiple serving cells. As shown, at 510, the WTRU may receive data from cells in a multi-point set. As described above, the multi-point set may include a primary serving cell and one or more assisting cell(s). At 520, a reporting event may be triggered based on the cell quality of the primary serving, the assisting serving cell, and/or a non-assisting cell. The reporting event may correspond to a multi-point management event.

In an embodiment, the WTRU may be configured with one or more multi-point management events by the network. For example, the network and the WTRU may exchange capability indications, and the network may configure the WTRU to report multi-point management events. The multi-point management events may include, but not limited to a cell adding event, a cell removal event, and/or a cell replacement event.

Upon triggering a reporting event, a measurement report indicating the reporting event may be sent to the network. The occurrence of a multi-point management event may trigger the WTRU to send a measurement report to the network. Based on the report, the network may make changes to the multi-point set, and may indicate the change to the WTRU via a measurement control message or a Radio Resource Control (RRC) reconfiguration message.

At 530, the WTRU may receive an indication of change to the primary serving cell and/or the assisting serving cell. The indication may include a control message or a RRC reconfiguration message. The control message or RRC reconfiguration message may indicate that the cell that triggered the reporting event is to replace an existing assisting cell. The control message or RRC reconfiguration message may include connection information associated with the cell that triggered the reporting event such that the WTRU may establish a connection with the cell. At 540, upon receiving the control message or RRC reconfiguration message, the WTRU may modify the multi-point set based on the indication of the change. For example, the WTRU may connect to the new assisting cell based on the connection information. The WTRU may start to receive data from a new assistant cell, may stop receiving data from a previous assistant cell that has been removed from the multipoint set by the network, or may replace a previous assistant cell with a new assisting cell. The WTRU may receive data via the primary serving cell, the new assisting cell, and/or existing assisting cell or secondary cell(s).

A cell, such as a neighboring non-serving cell, may be added to a multi-point set. A neighboring cell may be added to the multi-point set as an assisting cell. For example, the network may add a non-serving cell to the multi-point set upon receiving a measurement report from the WTRU. The measurement report may be triggered by a reporting event, such as a cell adding event. The cell adding event may be an intra-frequency event. In an example HSPA system, the cell adding event may correspond to adding a non-active HS-DSCH cell in the DCH active set to the HS-DSCH active set. In an example LTE system, the cell adding event may correspond to adding a neighboring cell to the LTE multi-point set.

The cell adding event may be triggered such that the best cells, and/or cells with a perceived channel quality above a certain threshold, may be added to the multi-point set. The cell adding event may be triggered such that cells within a reporting range may be added to the multi-point set. In an example HSPA system, the cell adding event may correspond to a new event such as event 1K. In an example LTE system, the intra-frequency event may correspond to a new event such as event A6. Event labeling is used for exemplary purposes, and the events described herein may be labeled differently.

In an embodiment, the cell adding event may be triggered when the channel quality of a non-assisting cell or a non-serving neighboring cell reaches or exceeds a predetermined threshold. For example, the WTRU may determine that channel quality measurement of a non-active HS-DSCH cell in the DCH active set exceeds a pre-configured absolute threshold for a pre-configured time-to-trigger period. Based on the determination, the WTRU may trigger the cell adding event, for example, event 1K.

The cell adding event may be triggered when the measurement quality of a non-assisting reaches or exceeds a weighted measure of the cells in the multi-point set. Cell measurement quality may include, but not limited to, “pathloss”, “CPICH Ec/No” or “CPICH Received signal code power (RSCP)”, Reference Signal Received Power (RSRP) or Reference Signal Received Quality (RSRQ) or Received Signal Strength Indicator (RSSI), and/or any other kind of measurement quantity configured by the network. The measurements of channel quality may be performed on a reference channel, such as but not limited to, CPICH, CRS, CSI-RS associated to a point, a new reference channel used transmitted by a point in CoMP. In an embodiment, the measurement quantity may include channel state information (CSI) and/or Channel-Quality Indicator (CQI). In an embodiment, cell adding event may be triggered when the measurement quality of a non-assisting reaches or exceeds the measurement quality of a predetermined number of best cells.

In an embodiment, cells within a reporting range with respect to the serving cell or the primary cell may be added to the multi-point set. The cell adding event may be triggered when a cell enters a multi-point reporting range. The reporting range may be applied relative to the serving cell or the primary cell. The reporting range may be signaled by the network.

In example HSPA system, the cell adding event such as event 1K may correspond to a non-active HS-DSCH cell or a non-assisting cell entering a configured multi-point specific reporting range. For example, if a non-serving HS-DSCH neighbor cell within the DCH active set enters a predefined reporting range for a predefined period of time, the WTRU may trigger a cell adding event.

For example, the entering condition for the cell adding event may be met when the following condition is met:

10 log(M_{non-active HS-DSCH})+CIO>10 log(M_{HS-dsch serving cell})−(R₁ₖ−H₁ₖ/2).

For example, if the weighted measure of the cells in the multi-point set is considered:

10 log(M_{non-active HS-DSCH})+CIO=>W*10 Log(sum(Mi))+(1−W) 10 log(M_{Hs-dsch serving cell})−(R₁ₖ−H₁ₖ/2)

where M_{non-active HS-DSCH} may include the measurement result of the cell in the DCH active set that is not configured or operating as an HS-DSCH cell entering the reporting range. CIO may include the individual cell offset for the cell in the DCH active set entering the reporting range. M_{HS-DSCH serving cell} may include the measurement result of the serving or primary HS-DSCH cell. R₁ₖ may include a reporting range constant. H₁ₖ may include the hysteresis for the event. Sum (Mi) may include the sum of the measurement results of the cells allowed to affect the reporting range. The cells may correspond to a multi-point set or to a set configured by the network.

In example LTE system, the event A6 may correspond to a neighbor cell entering a reporting range. For example, the entering condition for the cell adding event may be satisfied when the following condition is met:

Mn+Ofn+Ocn−Hys>Ms+Ofs+Ocs−R,

where, Mn and Ms may include the measurement results of the neighboring cell and serving cell or primary cell respectively. Ofn and Ofs may correspond to the frequency specific offset for the neighbor cell and serving cell or primary cell respectively. Ocn and Ocs may correspond to the cell specific offset for the neighbor cell and serving cell or primary cell respectively. Hys may include the hysteresis parameter for this event, and R may include the reporting range constant.

In an embodiment, frequency-specific offset or cell-specific offset may not be added. The entering condition for the cell adding event may be satisfied when the following condition is met:

Mn−Hys>Ms−R or Mn−Hys+R>Ms.

If the event is configured to factor in the weighted measure of the cells within a set, the formula may account for the sum of the measured cells that may affect the reporting range and the W factor.

The leaving condition for the cell adding event may be met when the conditions above described no longer hold. For example, the leaving condition for the cell adding event may be met when the following condition is met:

Mn+Ofn+Ocn+Hys<Ms+Ofs+Ocs−R

or

Mn+Hys<Ms−R.

In an embodiment, the cell adding event may be triggered, or the entering condition for the cell adding event may be met when the multi-point set is smaller than a predetermined size, such as a preconfigured or signaled minimum multi-point set size. For instance, if the minimum multi-point set size for HS-DSCH active set is 2, and the WTRU operates with an HS-DSCH active set of 1, the cell adding event may be triggered. In an embodiment, the event may be triggered if the entering condition described above is met, and the size of the multi-point set is lower than a predetermined size. For instance, if the size of the HS-DSCH active set equals to or is greater than the minimum multi-point set size, the cell adding event may not be triggered even if the entering condition is met.

In an embodiment, the cell adding event may be configured to be reported periodically, until the leaving condition is met. In an embodiment, the event may be configured to be reported periodically via measurement reports until a predetermined number of periodic reports are sent. The maximum number of reports may be predefined or configured as part of the measurement event or the reporting event. In an example HSPA system, the cell adding event such as event 1A may be configured with a measurement identifier that may uniquely identify the event.

The network may configure multiple events such as multiple event 1A's. For example, one event 1A may be configured to maintain the DCH active set, and one event 1A may be configured to maintain the HS-DSCH multi-point set. The event 1A that corresponds to HS-DSCH multi-point set may be configured such that the event triggering neighboring cell corresponds to a neighboring cell in the DCH active set. In an embodiment, the event 1A configured for or the cells for weighing purposes in the formula above may correspond to a different set of cells. Multiple event A3's may be configured such that a different hysteresis and offset (Off) may be considered when determining whether to trigger the cell adding event.

In an embodiment, when the network may receive a measurement report from the WTRU with the event. The network may add the reported cell to the multi-point set. If the WTRU currently operates with single cell, the event may trigger the configuration of multi-point cell operation.

The WTRU may trigger the event regardless of the size of the multi-point set. In an embodiment, if the multi-point set is full, the network may not add the reported cell to the multi-point set. In an embodiment, if the multi-point set is full, the network may add the reported cell to the point set if the channel quality of the cell is better than a current active cell in the multi-point set by a predetermined value.

The cell adding event may trigger a measurement report. The WTRU may send a measurement report that may include an indication of the event that triggered the measurement report, such as the cell adding event. The measurement report may include an indication of the cell that triggered the cell adding event, such as the non-assisting cell with channel quality exceeding a predetermined threshold. The measurement report may include the channel quality of the cells in the DCH active set and/or the channel quality of the cells in the multi-point set.

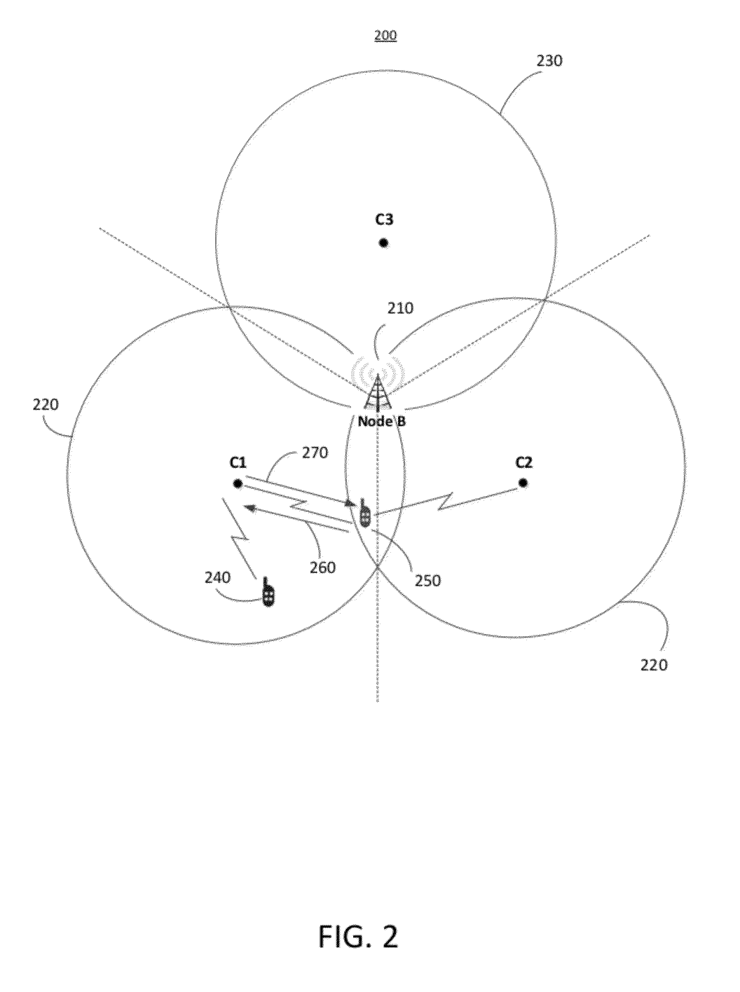

FIG. 2 is a diagram of adding a cell to a WTRU's multi-point set. In FIG. 2, cells C1, C2 and C3 may belong to the same NodeB 210. Cells C1 and C2 may operate in the same frequency such as frequency 220. In an embodiment, cell C3 may operate in a different frequency such as frequency 230. In an embodiment, cell C3 may operate in the same frequency as C1 and C2 such as frequency 220.

As shown in FIG. 2, the WTRU may be at position 240 with cell C1 as the primary serving cell. The network and the WTRU may exchange capability indications, and the network may configure the WTRU to report multi-point management events via a measurement control message or a RRC reconfiguration message. The measurement control message or RRC reconfiguration message may include the triggered multi-point management event and mobility information. The WTRU may move to a cell edge position such as position 250. The WTRU may monitor cell quality of serving cell(s) and neighboring cell(s). For example, the WTRU may perform neighbor cell measurements such as measuring the signal quality of C2. Based on the measurements, the WTRU may detect that the signal quality of C2 may obtain or exceed a certain threshold. In an embodiment, based on the measurements, the WTRU may detect that the WTRU is within a reporting range as configured by the cell adding event for time-to-trigger duration. For example, the WTRU may detect that the WTRU has entered a reporting range associated with cell C2.

The WTRU may trigger the cell adding event. For example, event 1K and/or event A6 described above may be triggered. The WTRU may send a measurement report such as measurement report 260 to the network. Based on the measurement report, the network may add cell C2 to the WTRU's multi-point set. The WTRU may receive a RRC message such as RRC configuration message 270 from the network. The RRC configuration message 270 may indicate that cell C2 has been added to the WTRU's multi-point set. As such, at position 250, the WTRU may be configured with multiple serving cells such as cell C1 and C2. C1 may serve as the WTRU's primary cell, and C2 may serve as the WTRU's assisting cell.

In an embodiment, a cell removing event may trigger the removal of one or more cells from a multi-point set. For example, only cells above a certain quality threshold or within a reporting range may be kept in the multi-point set.

In an example HSPA system, the cell removing event may correspond to event 1L. In an example LTE system, the cell removing event may correspond to event A7. The cell removing event may correspond to event A6 (e.g., the cell adding event) by setting the reportonLeave bit in the event configuration. The cell removing event may be triggered when the condition(s) for cell(s) to be in the multi-point set is no longer met. The occurrence of the cell removing event may trigger a measurement report.

For example, the cell removing event may be triggered when the channel quality of a cell in the multi-point set or the HS-DSCH active set goes below a predetermined absolute threshold. For example, if the WTRU determines that the channel quality measurement of an HS-DSCH cell in the HS-DSCH active set is lower than a preconfigured absolute threshold for a configured time-to-trigger period, the cell removing event may be triggered.

For example, the cell removing event may be triggered when an assisting cell leaves a reporting range. Event 1L may be triggered when the WTRU leaves the configured multi-point specific reporting range for a predefined period of time. In an example HSPA system, event 1L may be triggered when a HS-DSCH assisting cell leaving a multi-point configured specific reporting range. If a cell in the HS-DSCH multi-point set leaves a certain predefined reporting range for a predefined period of time, the WTRU may trigger the cell removing event.

For example, the cell removing event may be triggered if the following is met:

10*log(M_{HS-DSCH set cell})+CIO<=W*10*log(sum(Mi))+(1−W)*10*log(M_{HS-DSCH serving cell})−(R₁ₖ+H₁ₖ/2),

where M_{HS-DSCH set cell} may include the measurement result of the cell in the HS-DSCH multi-point set leaving the reporting range. CIO may include the individual cell offset for the cell in the HS-DSCH multi-point set leaving the reporting range. M_{HS-DSCH serving cell} may include the measurement result of the serving or primary HS-DSCH cell. R₁ₖ may include a reporting range constant. H₁ₖ may include the hysteresis for the cell removing event. Sum (Mi) may include the sum of the measurement results of the cells allowed to affect the reporting range. The cells may correspond to a multi-point set or to a set configured by the network.

In an example LTE system, event A7 may correspond to a primary cell leaving a reporting range. For example, the event may be triggered if the following condition is met:

Mn+Ofn+Ocn+Hys<Ms+Ofs+Ocs−R,

where Mn may include the measurement result of the neighboring cell that is a part of the multi-point set, and Ms may include the serving cell or primary cell measurement. Ofn and Ofs may correspond to the frequency specific offset for the multi-point set neighbor cell and serving cell or primary cell respectively. Ocn and Ocs may correspond to the cell specific offset for the neighbor cell and serving cell or primary cell respectively. Hys may include the hysteresis parameter for the event, and R may include the reporting range constant.

In an embodiment, no frequency specific offset or cell specific offset may be added. The cell removing event may be triggered when Mn+Hys<Ms−R.

In an embodiment, the cell removal event may not be triggered if one cell meets the leaving condition and another cell meets the entering condition at the same time. A cell replacement event may be triggered. When the network receives the cell replacement event, the network may remove the cell that meets the leaving condition from the multi-point set.

In an embodiment, an event such as a cell replacement event may be triggered when a non-assisting cell becomes better than an assisting cell in the multi-point set. For example, the WTRU may determine that a quality of a non-assisting cell exceeds that of an assisting cell by a predetermined threshold for a predetermined period of time. The WTRU may trigger the cell replacement event.

In an example HSPA system, the quality of a non-active HS-DSCH cell/non-active assisting cell may become better than the quality of an active secondary HS-DSCH cell/assisting cell in the HS-DSCH active set/multipoint set by a configured threshold for a configured period of time. The non-active HS-DSCH cell may be in the DCH active set. In an embodiment the non-active assisting cell may not be in the DCH active set. In an embodiment the non-active assisting cell may be on a different frequency. A non-active assisting cell may correspond to a non-configured multi-point cell. For example, a non-active assisting cell may be a cell in the DCH active set that is not configured for multipoint or HS-DSCH operation. For example, the non-active assisting cell may correspond to a cell that is not in the DCH active set and not configured for multipoint operation. Active assisting cell(s) may correspond to cells that are configured to be multipoint cells. An active assisting cell may be configured and activated (e.g. the WTRU is monitoring the HS-SCCH/HS-DPSCH) or deactivated (e.g. configured in the WTRU but the WTRU is not monitoring the HS-SCCH/HS-PDSCH). An active or non-active assisting cell may be in the preconfigured target cell list described below, and the network may not dynamically activate or deactivate non-active and active assisting cell(s). In an embodiment, only active multipoint cells (e.g. configured or preconfigured may be in the target cell list that the network may perform fast activation/deactivation of the active cells.

The cell replacement event may correspond to event 1M. In an embodiment, the cell replacement event may correspond to event 1K. The active HS-DSCH cell may correspond to a primary HS-DSCH serving cell, or an assisting cell in the HS-DSCH active set/non-primary serving HS-DSCH cell.

For example, if event 1D, or the change of best cell event is triggered, event 1M may not be triggered. Event 1D may be triggered when a non-active HS-DSCH cell becomes better than the serving HS-DSCH cell. If event 1D is triggered when a WTRU operates in a multi-point configuration, the channel quality of other cells in the multi-point set may be reported. The measurement report may include the measurement results of the cells in the multi-point set.

For example, the entering condition for the cell replacement event may be satisfied when the following is met:

10*log(M_{non HS-DSCH set cell})+CIO_{non HS-DSCH set cell}>=10*log(M_{HS-DSCH set cell})+CIO_{HS-DSCH set cell}+H_{1M}/2,

where M_{non HS-DSCH set cell} may include the measurement result of an assisting cell, or a cell not in the HS-DSCH multi-point set. CIO_{non HS-DSCH set cell} may include the individual cell offset of the non-assisting cell or the non HS-DSCH multi-point set cell becoming better than an HS-DSCH multi-point set cell. M_{HS-DSCH set cell} may include the measurement result of an assisting cell, or a cell in the HS-DSCH multi-point set. CIO_{HS-DSCH set cell} may include the individual cell offset of an HS-DSCH multi-point set cell. H_{1M} may correspond to the hysteresis parameter for the cell replacement event 1M. In an embodiment, the cell replacement event may correspond to event 1K, and H₁ₖ may replace H_{1M} in the above described formula, where H₁ₖ may correspond to the hysteresis parameter for the cell replacement event 1K.

In an example LTE system, an event such as event Ax (e.g., A8) may be triggered when the quality of a non-assisting cell or a non-serving neighboring cell becomes better than an assisting cell or a serving cell in the multi-point set. The serving cell may be a cell in the multi-point set, or an assisting cell. For example, the entering condition for the replacement event may be considered as satisfied when the following condition is fulfilled:

M_{new}+Ofn+Ocn−Hys>M_{inMPset}+Ofs+Oe_{inMPset}+Off

where M_{new} may include the measurement result of a non-assisting cell or a cell not included in the multi-point set and Ofn and Ocn correspond to a frequency and cell specific offset for the frequency for the measured cell. M_{inPMset} may include the measurement result of the assisting cell or the cell in the multi-point set with the lowest measurement result. Oc_{inMPset} may include the cell specific offset for the cell that is becoming worse than the new cell. Ofs may include the frequency offset of the cell that is becoming worse than the new cell. Off may include the offset parameter for the event.

In an embodiment, If no frequency specific offsets are added, or if the CoMP management set is performed on one frequency, then the multipoint event may be triggered when

M_{new}+Ocn−Hys>M_{inMPset}+Oe_{inMPset}+Off.

The network may configure the cell replacement event via a measurement control message or via a RRC reconfiguration message in the mobility control information. The network may provide the WTRU with one or more of parameters such as threshold value(s), hysteresis, and/or time to trigger. The WTRU may determine that the channel quality measurement of a cell in the DCH active set exceeds a cell in the HS-DSCH active set by a configured value or percentage for the configured time to trigger. The WTRU may trigger a measurement report indicating the cell replacement event.

In one embodiment, the cell replacement event may be triggered when a non-assisting neighboring cell is within a reporting range, or the quality of is a non-assisting neighboring cell is above a threshold. For example, if the quality of the non-assisting cell is better than an assisting cell by a configured threshold, the cell replacement event may be triggered. For example, if the quality of the non-assisting cell is not within an acceptable range when compared to the serving primary cell, the cell replacement event may not be triggered.

The cell replacement event may be triggered when a non-assisting cell such as Mnew has become better than an assisting cell, M_{inMPset} by a certain threshold. The threshold may account for cell specific offsets. For example, in an example LTE system, the cell replacement event may be triggered when M_{new}+Ocn−Hys>M_{inMPset}+Oe_{inMPset}+Off. The cell replacement event may be triggered when a non-assisting cell such as Mnew is within a reporting range when compared to the serving cell. For example, in an example LTE system, the cell replacement event may be triggered when M_{new}−Hys>Ms−R or M_{new}−Hys+R>Ms. M_{new} may include the measurement results of a non-assisting cell, M_{inMPset} may include the measurement results of a cell in the multipoint set, and Ms may include the measurement results of the serving cell or primary cell. Ocn and Oc_{inMPset} may correspond to the cell specific offset for the neighbor cell and a cell in the multipoint set respectively. Hys may include the hysteresis parameter for this event, and R may include the reporting range constant. Off may include the offset parameter for the event.

In an embodiment, the cell replacement event may be triggered when no cells are currently configured in the multipoint set, or when the number of cells in the multipoint set is less than the maximum allowed size, and a non-assisting cell is within an acceptable range.

In an embodiment, a report on leave event may be configured. The report on leave event may be triggered when an assisting cell is no longer within an acceptable range. For example, if an assisting cell is not within a reporting range or the quality of is an assisting neighboring cell is below a threshold, the event with a reason report on leave may be triggered. If the event persists for time-to-trigger, then a measurement report indicating the event and the quality of the measured cells may be triggered. The measurement report may not be triggered if the report on leave event is triggered before the time-to-trigger lapses.

In an embodiment, a multi-point management event may be triggered when the condition for adding a cell, removing a cell, or replacing a cell is met. The multiple management event may be referred to as event 1K.

If the multi-point management events are configured to be linked to a single frequency, the assisting cells in the same frequency as the primary cell or in the configured frequency may be evaluated and compared to determine whether events should be triggered. For example, if an assisting cell is configured in a secondary frequency, the replacement event may be triggered if a non-assisting neighboring cell on the primary frequency or configured frequency becomes better than an assisting cell in the same frequency by a certain threshold for a predefined period of time.

In an embodiment, cell replacement events, cell adding events, and/or cell removing events may be triggered for cells in the same Node B, or intra-Node B cells. The cells may include the primary cell and/or serving HS-DSCH cell in a frequency in the Node B. In an embodiment, only neighboring cells in the same Node B may be evaluated to determine whether a replacement event is to be triggered.

The WTRU may determine whether a non-assisting cell or neighboring cell belongs to the same Node B as a serving cell. For example, the WTRU may compare the TPC combination index of a neighboring cell to the TPC combination index of the serving primary cell. If the combination index of the cell is the same as that of the primary cell, the WTRU may determine that the neighboring cell belongs to the same Node B. For example, the WTRU may compare the RG combination index. If the RG combination index is the same as that of the primary cell, the WTRU may determine that the neighboring cell belongs to the same Node B. For example, the WTRU may determine that the neighboring cell belongs to the same Node B based on an explicit indication of cells belonging to the same NB. The indication may be received when a cell is added to the DCH active set. The indication may be received when a Primary Synchronization Code (PSC) or PCI of the sectors in the same Node B is provided to the WTRU.

In an embodiment, the cell replacement events may be triggered for a subset of cells configured by the network. A list of cells for which the WTRU may trigger the events or perform condition evaluation for may be provided to the WTRU by the network as part of the measurement control, or as part of a message. The network may indicate a list of PSCs or PCIs that the WTRU may trigger the event.

In an embodiment, one multi-point set may be maintained across multiple frequencies. The events described above are applicable to cell in one or multiple frequencies. For example, the WTRU may measure neighboring cells in multiple frequencies, and the events described above may be reported for an non-assisting cell in one of the multiple configured frequencies. For each event, a frequency specific offset may be configured and used in the evaluation of the triggering condition(s).

For example, a cell adding event such as event 1K or A6 may be reported for a cell in a secondary frequency. A cell replacement event such as event 1M may be triggered and reported when a cell in a secondary frequency becomes better than an assisting cell in the primary frequency or in the secondary frequency. In an example, a cell replacement event may be triggered when a non-active assisting cell becomes better than an assisting cell in a secondary frequency or in a primary frequency. The neighboring cells in the active/configured frequencies may be monitored. In an embodiment, a preference may be given to one or more frequency over other(s). For example, frequency-indicating offsets may be used to evaluate the event triggering conditions.

In an embodiment, a multi-point set may be maintained independently for each frequency. A set or subset of events may be configured for each frequency. Event(s) for different frequencies may be triggered independently, and measurement reports that correspond to the events may be sent to the network independently. Based on the reports, the network may update the sets and may configure the cells associated with the multi-point operation. In an embodiment, the network may configure the WTRU to report the measurements of cells on multiple frequencies.

The WTRU may perform measurements and report events on one frequency. Multi-point transmission may take place from cells located on different frequencies. The WTRU may use measurements performed on one frequency, such as the primary frequency, to update the multi-point set.

For example, events may be triggered based on the measurement of neighboring cells on the primary frequency. Based on the measurements on a primary frequency, the network may add the corresponding overlapping cell on a secondary frequency as a multi-point transmission cell or assisting cell. The network may not need to first configure the cell on the primary frequency that triggered the event as an assisting cell. The network may configure an assisting cell on the frequency that triggered an event and an assisting cell on the secondary frequency, such as the corresponding cell in the secondary frequency.

The cells in primary and secondary frequencies on overlapping sectors may be configured in the WTRU as part of an RRC configuration. The network may dynamically control which cell may be used for multi-point transmissions via fast activation and/or deactivation. Cell activation and deactivation may be dynamically controlled via physical layer signaling or Medium Access Control (MAC) control element (CE) signaling, which will be described in more detail below.

The WTRU may measure and evaluate the event criteria across multiple frequencies. A cell on the primary frequency may be associated with a cell on the secondary frequency. The network may provide associations between cells to the WTRU such that WTRU may determine which PCI or PSC to measure for event triggering purposes. For example, if a cell on a secondary frequency is added to the multi-point set, the network may send the PSC or PCI of the associated cell on the primary frequency to the WTRU. For example, the WTRU may measure and evaluate multi-point management event criteria of a cell on the primary frequency, and may report an associated cell in the secondary frequency leaving the reporting range or a cell replacement event for an associated cell in a secondary frequency.

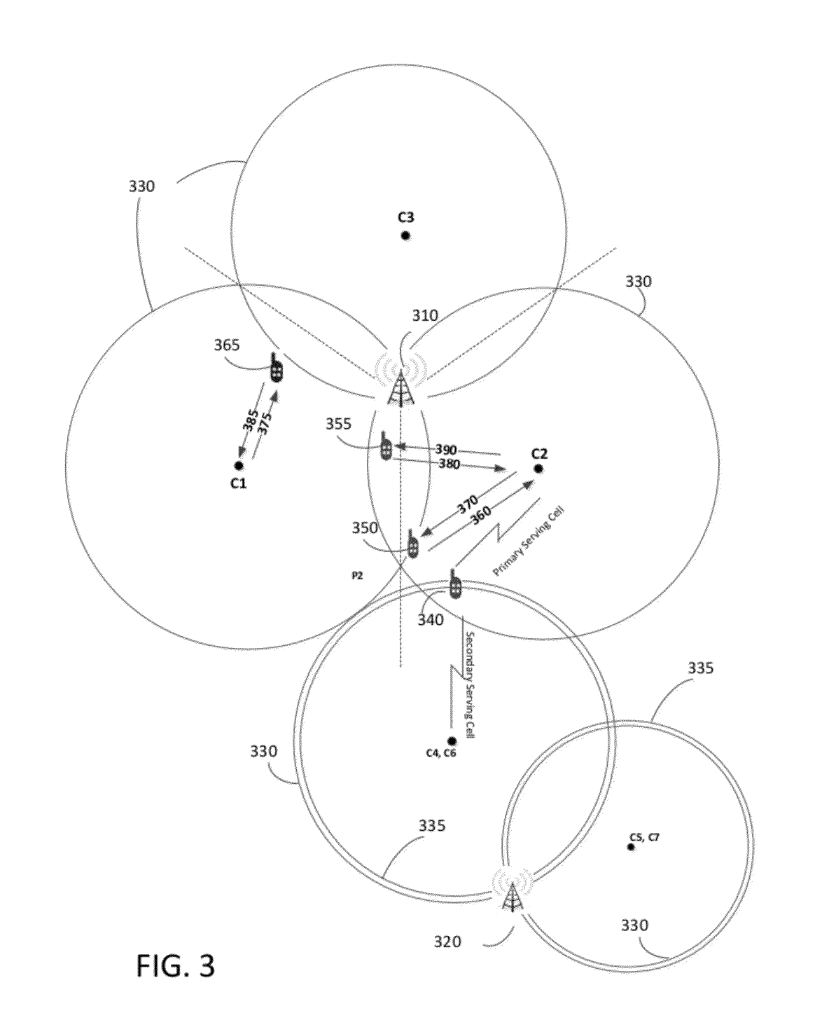

FIG. 3 illustrates example multi-point set operations. The WTRU may operate on one or more of cells, such as cells C1-C7. As shown, cells C1, C2 and C3 may belong to NodeB 310. Cells C4, C5, C6, and C7 may belong to NodeB 320. Cells C1, C2 and C4 may operate on the same frequency such as frequency 330. Cells C6 and C7 may operate on the same frequency such as frequency 335.

Referring to FIG.3, at position 340, the multi-point set for the WTRU may include cells C2 and C4. The WTRU may receive data via both cells C2 and C4. Cell C2 may serve as the primary serving cell, and cell C4 may serve as the assisting cell. As shown, when the WTRU moves to position 350, the WTRU may move out of the coverage area of cell C4, and may move into the coverage area of cell C1. Cell C1 may not be part of the multi-point set for the WTRU.

For example, the WTRU may measure cell quality of cells C1, C2 and C4. The WTRU may detect that the measurements on cell C1 may become stronger than the measurements on cell C4 at position 350. The WTRU may detect that the quality of the non-assisting cell such as C1 becomes better than the assisting cell such as C4 by a predetermined threshold for a time-to-trigger period of time. The WTRU may detect that the WTRU enters a reporting range of cell that may not be part of the multi-point set, such as C1. Based on the measurements, the WTRU may trigger a measurement event, for example event 1M for HSPA or event A8 for LTE as described above. The event may trigger the WTRU to send a measurement report 360 to the network if the event persists for a time-to-trigger period of time.

Based on the measurement report 360, the network may replace cell C4 with cell C1 in the WTRU's multi-point set. The network may send RRC reconfiguration message, such as message 370, to the WTRU. The RRC message may indicate an assisting cell change, such as changing from cell C4 to Cell C1. As such, at position 350, cell C1 may become the WTRU's new assisting cell or secondary serving cell, and C2 may remain as the primary serving cell. Cell C4 may be removed from the multi-point set. The WTRU may receive data via cells C1 and C2.

Referring to FIG.3, the WTRU may move to position 355, and may detect that cell C1's measurements may be stronger than cell C2's measurements by a predetermined threshold. A cell swapping event may be triggered when the cell quality of an assisting cell exceeds the cell quality of the primary cell by a predetermined threshold. For example, based on the measurement, the WTRU may determine that the assisting cell C1 exceeds the measurement of the primary serving cell C2 by a predetermined threshold. A cell swapping event, for example event 1D, may be triggered. The cell swapping event may trigger the WTRU to send a measurement report 380 to the network. The WTRU may report the quality of cells in the multi-point set, such as C1 and C2. The measurement report 380 may include the quality of other cells in the multi-point set.

Based on the measurement report, the network may simultaneously change the primary and the assisting cells of the WTRU. For example, if the non-primary serving cell that triggered the event is an assisting cell, simultaneous change of primary and secondary serving cells may be performed. The network may send a RRC reconfiguration message 390 to the WTRU. The RRC reconfiguration message 390 may indicate that the event trigger cell, or the previous assisting cell such as cell C1, is the WTRU's new primary serving cell, and the previous primary serving cell such as C2 is the new assisting serving cell.

Referring to FIG. 3, the WTRU may move to position 365. As shown, position 365 is out of coverage area of cell C2, but still in the coverage area of cell C1. For example, the measurement for cell C2 may be below certain threshold, or cell C2 may be outside of a predetermined reporting range. A cell removing event, such as event 1L for HSPA or event A7 for LTE, may be triggered by the WTRU. The WTRU may send a corresponding measurement report 385 to the network. Based on measurement report 385, the network may remove cell C2 from the WTRU's multi-point set. The network may send a RRC message such as message 375 to the WTRU. The message 375 may indicate that cell C2 has been removed from the multi-point set. Upon receipt of the message 375, the WTRU may remove C2 from the multi-point set. For example, the WTRU may receive data from a single serving cell such as C1.

In an embodiment, the WTRU may be pre-configured with one or more target assisting cells. Target assisting cells may be dynamically activated or deactivated. For example, the network may dynamically manage multi-point transmission by ordering the WTRU to activate and/or deactivate pre-configured target cells. When an assisting cell is activated, the WTRU may receive data via the assisting cell and monitor the downlink of the assisting cell. When an assisting cell is deactivated, the WTRU may stop receiving data via the assisting cell and may stop monitoring the downlink of the assisting cell.

The network may determine when to pre-configure a target assisting cell based on one or more of the multi-point management events described above. The WTRU may receive data via a subset of the configured target assisting cells. In an embodiment, upon pre-configuration of a target assisting cell, the WTRU may consider the cell activated and may initiate DL reception of data and feedback reporting for the activated cell. In an embodiment, upon configuration or pre-configuration of an assisting cell, the WTRU may consider the target assisting cell status as configured but not activated or deactivated. The WTRU may wait for an order or L2 message to activate the configured or pre-configured assisting cell. In an embodiment, the WTRU may be configured with a target assistive cell, and the configuration information may indicate whether the configuration is a pre-configuration. For example, if the configuration is a pre-configuration, the initial status of the target assisting cell may be deactivated. If the configuration is not a pre-configuration, the initial status of the target cell may be activated. In an embodiment, the network may configure a subset of target assisting cells with an information element in the RRC reconfiguration message, and may pre-configure another subset of target assisting cells using a different information element. For example, one information element may be used to configure target assisting cell(s) that should be activated upon configuration. Another information element may be used to pre-configure target assisting cell(s) that may be dynamically activated later on.

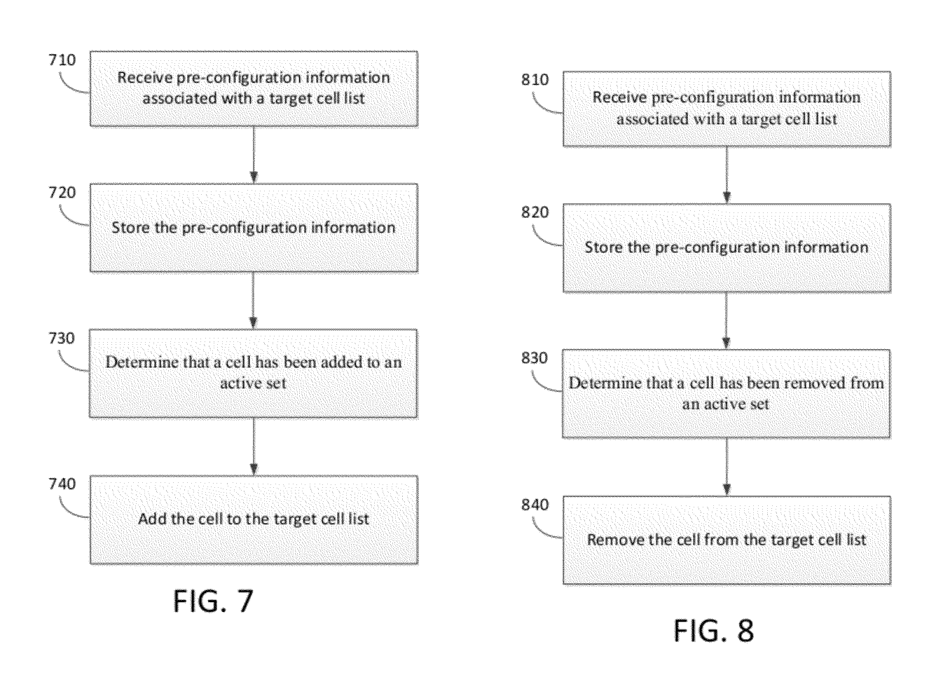

FIG. 6 illustrates an example process for receiving data from multiple serving cells. As shown, at 610, the WTRU may receive pre-configuration information of the target cells. For example, the WTRU may be pre-configured with connection information associated with the target cells via RRC configuration messages. In an embodiment, the target cells may only include target assisting cells that may serve as assisting cells upon activation. In an embodiment, the pre-configuration information may indicate whether target cell may serve as a primary cell, an assisting cell, or both. At 620, the WTRU may receive an indication to activate a preconfigured target cell. For example, the indication may indicate that the target cell is to be activated as the primary serving cell or as an assisting serving cell. The indication may include an order from the network or the NodeB, which will be described in more detail below.

At 630, the WTRU connect to the target cell based on the preconfigured connection information associated with the target cell. For example, if the order indicates that the target cell is to serve as a primary cell upon activation, the WTRU may connect to the target cell as a primary serving cell. For example, if the order indicates that the target cell is to serve as an assisting cell upon activation, the WTRU may connect to the target cell as an assisting serving cell. At 640, the WTRU may start receiving data from the activated target cell.

FIG. 7 illustrates an example process for receiving data from multiple serving cells. As shown, at 710, the WTRU may receive pre-configuration information of the target cells on the target cell list.

At 720, the WTRU may store the pre-configuration information. For example, the WTRU may maintain a list of target assisting cells in a variable. For example, the WTRU may store the list of target assisting cells and pre-configuration information in memory such as non-removable memory 106 and/or removable memory 132.

The list may be updated when the WTRU receives pre-configuration information from the network. At 730, the WTRU may determine that a cell has been added to the active set. At 740, the WTRU may add the pre-configured assisting cell to the target cell list. The WTRU may receive pre-configuration information of a target assisting cell when the cell is added to the active set. The pre-configuration information may include target cell connection information such as connection parameters. Target assisting cell pre-configuration may be performed when a cell is added to a HS-DSCH active set or a multi-point set.

For example, the WTRU may receive an indication, such as an order, to activate a pre-configured target assisting cell. Upon receiving the indication, the WTRU may connect to the pre-configured target assisting cell using the pre-configuration information associated with the target cell, and start receiving data via the target cell. For example, the WTRU may receive an indication, such as an order from the network, to deactivate the target cell. The WTRU may stop receiving data via the target assisting cell. In an embodiment, if the WTRU is restricted to receive from two assisting cells at a time, the WTRU may deactivate an activated assisting serving cell, and activate the target assisting cell indicated in the order.

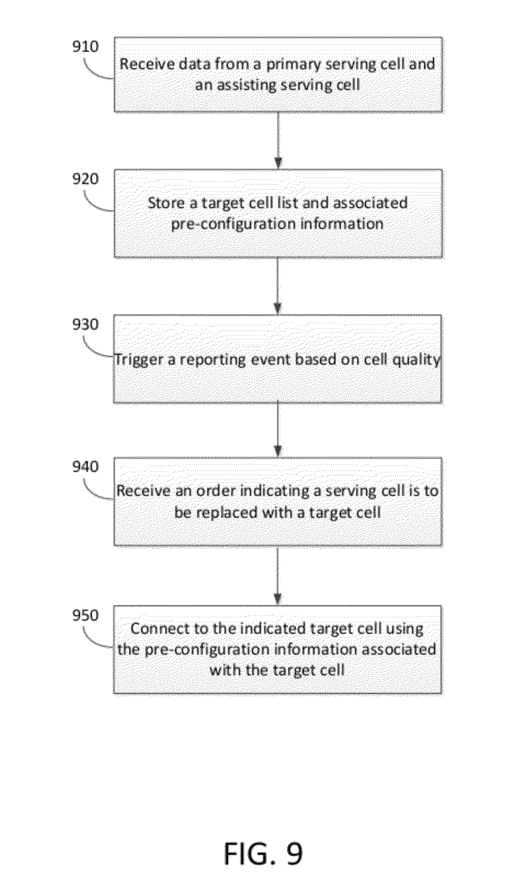

FIG. 8 illustrates an example process for maintaining a target cell list. As shown, at 810, the WTRU may receive pre-configuration information of the target cells on the target cell list. At 820, the WTRU may store the pre-configuration information. For example, the WTRU may store the list of target cells and pre-configuration information in memory such as non-removable memory 106 and/or removable memory 132. At 830, the WTRU may determine that a target cell has been removed from the active set. At 840, the WTRU may remove the target cell from the target cell list. The WTRU may remove a cell that leaves the active set from the list of pre-configured target cells. The WTRU may delete the pre-configuration information of target cell from memory.

FIG. 9 illustrates an example process for maintaining a target cell list. As shown, at 910, the WTRU may receive data from the primary serving cell and an assisting serving cell. At 920, the WTRU may store the pre-configuration information of the target cells on the target cell list. For example, the WTRU may store the list of target cells and pre-configuration information in memory such as non-removable memory 106 and/or removable memory 132. At 930, the WTRU may trigger a reporting event based on the cell quality of the primary serving cell, the assisting serving cell(s), and/or the target cells. The reporting event may be triggered by one or more of the multipoint management event(s) described above. The WTRU may send a measurement report to the network indicating the report event, and a target cell that triggered the event. The network may determine to replace a serving cell based on the event that triggered the report. At 940, the WTRU may receive an order from the network or an eNodeB indicating that the primary serving cell or the assisting serving cell is to be replaced with a target cell. At 950, the WTRU may connect to the target cell using the pre-configuration information of the target cell. The WTRU may stop receiving data from the previous primary or assisting serving cell.

The WTRU may receive information during pre-configuration of a target cell. For example, the network may send the WTRU target cell pre-configuration information. The target cell pre-configuration may include configuration parameters for a cell to become an assisting serving cell and/or a primary serving cell. The preconfigured information may indicate that a target cell may become a primary serving cell, an assisting cell, and/or a secondary serving cell upon activation. A target cell that may become a primary serving cell may be referred to as a target primary serving cell. A target cell that may become an assisting serving cell may be referred to as a target assisting serving cell or target secondary serving cell. The preconfigured information may include an information element indicating the target primary serving cell, and an information element to configure the cell as a potential assisting serving cell on the same frequency or on a different frequency. The network may pre-configure the WTRU with an information element to indicate whether the WTRU may perform a simultaneous primary and assisting serving cell change.

In an embodiment, a pre-configured target cell may be configured to potentially serve as a primary serving cell and an assisting cell. For example, the preconfigured information may include a one bit indication of whether the preconfigured target cell may serve as an assisting cell for multi-point transmission. The WTRU may determine whether to activate the target cell as a primary cell or an assisting cell based on an explicit indication in the configuration, or based on an indication in an activation order from the network. In an embodiment, a layer 1 activation order may only be used to activate an assisting cell in the pre-configured list as an assisting cell. The target cell may be configured with full configuration parameters for the target cell to become a primary serving cell. If the WTRU activates the target cell as an assisting serving cell, the WTRU may use a subset of the pre-configuration information to receive data on the target cell as an assisting cell.

Multiple serving cells, such as the primary and the secondary serving cells, may be changed simultaneously. This may be referred to as enhanced serving cell change. The cell quality of a non-assisting cell in the active set and the cell quality of a serving cell may be compared. The cell quality of two cells in the active set may be compared. The cell quality of the primary and the cell quality of the assisting serving cell may be compared.

Based on the comparison, simultaneous change of multiple serving cells may be triggered by one or more of the following reporting events. For example, event 1D, or a change of best cell event, may correspond to a target cell in the active set becoming better than the primary serving cell. For example, an event such as event 1Y may correspond to a simultaneous change of the primary best cell and change of secondary best cell. For example, an event such as event 1M may correspond to a cell in the active set becomes better that the assisting serving cell.

In an embodiment, the WTRU may maintain a list of target primary serving cells, or cells that may become a primary serving cell upon activation. A reporting event, such as event 1D, 1Y and/or 1M described above may be triggered based on the cell quality of a target primary cell. The target primary cell may include a HS-SCCH cell or a physical downlink control channel (PDCCH) of the cell. The WTRU may monitor the target primary cell that triggered the reporting event for a serving cell change order. The WTRU may receive an order from the target primary cell, and may perform a primary serving cell change. The target primary cell may become the new primary serving cell. With the target primary cell change, the WTRU may perform a change of one or more assisting cells.

The WTRU may determine whether the condition for replacing an assisting cell with a non-assisting cell. For example, the condition for replacing an assisting cell is met when a non-assisting cell in the active set is better than a current assisting serving cell by a predetermined threshold. If the condition for replacing an assisting cell is met, the WTRU may determine and activate the new assisting serving HS-DSCH cell.

In an embodiment, as described above, the WTRU may receive an order from the target primary cell that triggered the reporting event. The WTRU may determine the new assisting serving cell based on information in the order. For example, the order may indicate which pre-configured target cell may become the new assisting cell. An index in the order may correspond to a particular cell in the list of pre-configured cells. The index value may indicate which pre-configured cell may become the new assisting cell. Upon determining the new assisting cell, the WTRU may perform an assisting cell change simultaneous to the primary serving cell change.

In an embodiment, the WTRU may perform a simultaneous serving cell change when the order received over the target primary serving cell indicates that the WTRU should perform a primary cell change and an assisting cell change. The indication may be explicit or implicit. The indication may allow the network to control whether the primary and assisting serving cells may be switched simultaneously.

In an embodiment, the WTRU may determine whether to perform simultaneous serving cell change based on pre-configuration information. For example, the WTRU may determine whether to perform simultaneous serving cell change based on whether the assisting HS-DSCH information is pre-configured, whether an information element indicates that the target cell may be used as an assisting HS-DSCH cell is set, and/or whether a pre-configured information element indicates that a simultaneous change may be allowed is set.

A reporting event, such as event 1D, 1Y and/or 1M described above may be triggered based on the cell quality of a target assisting cell. The WTRU may monitor the target assisting cell that triggered the reporting event for an order. The WTRU may receive an order from the target assisting cell. The order may indicate that the WTRU should perform a primary serving cell change simultaneous to the assisting serving cell change. The WTRU may determine the new primary cell based on an indication in the order of which cell may become the new primary cell. The WTRU may change the primary serving cell and the assisting cell simultaneously based on the order.

In an embodiment, the WTRU may monitor the HS-SCCH of the target primary and the target assisting cells. The target primary and the target secondary cells may include the cells that triggered a measurement event, or the cells determined as the new best primary cell and the new best secondary cell. The new primary serving cell and assisting serving cell may be determined based on the measurement qualities as reported in the measurement report to the network.

When the WTRU receives an order from one of the target cells, such as the new best primary cell or the new best secondary cell, the WTRU may perform the serving cell change for both cells. The WTRU may ignore the second redundant order.

In an embodiment, even if the WTRU monitors the HS-SCCH of target primary and the target secondary cells, the WTRU may expect to receive an order from only one of the cells. The WTRU may not have a prior knowledge of which target cell may send the order. When the WTRU receive an order indicating a serving cell change, the WTRU may perform the serving cells change for both cells. For example, the WTRU may make the best new cell the new primary serving cell and the best secondary cell the new secondary best cell. The WTRU may make the cell that sent the order indicating the serving cells change the new primary serving cell and the other cell the new secondary serving cell. The target cells may be monitored for a maximum period of time.

In an embodiment, the WTRU may perform the serving cell changes upon receiving an order from the new best serving cell and an order from the new best secondary cell indicating a serving cell change. The WTRU may start a timer, for instance called T_{order}, when the WTRU receives the first order. Timer T_{order} may be stopped when the WTRU receives the second order. If T_{order} expires before the second order is received, the WTRU may switch from multi-point operation to single-cell operation by making the cell that sent the order the new primary serving cell. The WTRU may stop receiving data from the previous assisting cell.

In an embodiment, primary serving cell change and the secondary serving cell change may be performed independent of each other. For example, the WTRU may change best primary serving cell without changing the best secondary serving cell, or vice versa. For example, when an order is received from one of the target cells, the WTRU may perform a serving cell change for the cell on which the order is received.

In an embodiment, the WTRU may monitor the HS-SCCH of the cell that triggered the event. For example, the WTRU may not change both the primary and the secondary cells simultaneously, and may wait for a message or a new order to perform cell change for the other cell. To illustrate, the WTRU may receive an order from a target cell. The WTRU may perform a primary serving cell change on the target cell. The WTRU may start a timer, such as T_{secondary}, upon receiving the order from the target primary cell. The WTRU may wait for a message from the network indicating which cell is the new assisting cell. The WTRU may wait for an activation order indicating which cell is the new assisting cell, and/or indicating which previous/current assisting cell is to be de-activated. The message may include a complete configuration of the assisting cell. The message may include an index pointing to one of the cells in the pre-configured target cell list. The WTRU may wait for another order from the new primary serving cell indicating what the new secondary cell should be. Upon receipt of the message or the other order indicating what the new assisting serving cell should be, the WTRU may stop timer T_{secondary}. If timer T_{secondary} expires before the indication is received, the WTRU may switch from multi-point operation to single cell operation. In an embodiment, if timer T_{secondary} expires before the indication is received, the WTRU may perform a single serving cell change by changing the primary serving cell to the target primary cell. The WTRU may wait for an explicit RRC message indicating an assisting cell change to change the assisting cell. In an embodiment, no timer is maintained. The WTRU may perform a target primary serving cell change upon an enhanced target cell change order and continue receiving on the previous/current assisting cell. The network may further activate a new assisting cell, or may explicitly deactivate the previous/current assisting cell without activating a new assisting cell via an order. In an embodiment, the network may activate and deactivate a cell using the same order.

In an example LTE system, the WTRU may monitor the PDCCH of the target cells, and may perform serving cell changes as described above with respect to monitoring HS-SCCH. The order may be sent and received on PDCCH or in a MAC CE.

In an embodiment, the primary serving cell may be changed independently of the secondary serving cell. The WTRU may receive an order indicating a change of primary serving cell, for example, from one of the pre-configured target cells or from the current assisting or secondary serving cell.

For example, the WTRU may trigger a “change of best cell” event such as event 1D or event A3. The cell that triggered the event may be a pre-configured target cell. The WTRU may start monitoring the HS-SCCH of the cell that triggered the event for a certain period of time. Once the WTRU receives an order from the target cell indicating a change of serving cell, the WTRU may make a new best cell the new primary serving cell. The order may be dedicated to multi-point serving cell change.

In an embodiment, the WTRU may listen for an order indicating a primary serving cell change on the HS-SCCH of the current secondary serving cell for a certain period of time. Upon receiving the order, the WTRU may make the new best cell the new primary serving cell. In an embodiment, the WTRU may monitor the HS-SCCH of the target primary cell. The order may be received over the target primary cell or over the current serving secondary cell. If the order is received, the WTRU may perform a primary serving cell change.

In an embodiment, the WTRU may receive the order indicating a change of the assisting serving cell. The order may be received, for example, from one of the pre-configured target cells or from the current primary serving cell or an activated assisting cell. The WTRU may trigger a serving cell change event. For example, the WTRU may trigger event 1X, “change of best secondary cell.” The cell that caused the trigger may a pre-configured target cell. The WTRU may start monitoring the HS-SCCH of the cell that triggered the event for a predetermined period of time. The WTRU may receive an order indicating a change of assisting serving cell, and may make the new best cell the new assisting serving cell.

In an embodiment, the assisting serving cell change or target cell activation/deactivation may be performed without the conditions or an event being triggered. The WTRU may receive an order activating a pre-configured target cell and/or deactivating a serving cell from the network. For example, the order may be received from the primary serving cell or from an assisting cell.

In an embodiment, the WTRU may listen for an order indicating a change of secondary serving cell from the current primary serving cell for a predetermined period of time. Upon receiving the order, the WTRU may make the new best secondary cell the new secondary serving cell. In an embodiment, the WTRU may monitor the HS-SCCH of the target secondary cell. The order may be received over the target secondary cell or over the current primary serving cell. If the order is received, the WTRU may perform an assisting cell change.

The orders described above may include a layer 1 (L1) HS-SCCH order, a PDCCH order, a MAC CE, and/or a layer 2 (L2) signal.

In an embodiment, one or more order types may correspond to SF-DC enhanced serving cell change, or may correspond to an activation order for a configured or preconfigured target assisting cell. For example, the target cell may not correspond to a serving cell. The order may be transmitted from a non-serving cell that may correspond to the cells that are not a primary or an assisting HS-DSCH cell on the same frequency. The order may be transmitted from a primary serving or an assisting serving cell. The HS-SCCH order on this cell may be an “HS-DSCH serving cell change” order. For example, the order type may be denoted x_{odt,1}, x_{odt,2},x_{odt,3}=‘000’ and x_{ord,1}, x_{ord,2}, x_{ord,3}=‘000’.

For example, the order may be transmitted from a serving cell. The order type may be a currently unused order type. For example, the order type may be denoted x_{odt,1}, x_{odt,2}, x_{odt,3}=‘010’ and x_{ord,1}, x_{ord,2}, x_{ord,3}=‘000’. The WTRU may interpret the order as a serving cell change order when received from a serving cell. In an embodiment, the order type may correspond to an order transmitted from a non-serving cell.

In an embodiment, an order type may correspond to orders that indicate a serving cell change and the index of the cell in the pre-configured target cell list for which a serving cell change should be performed. The order type may be a currently unused order type. For example, the order type may be denoted x_{odt,1}, x_{odt,2}, x_{odt,3}=‘011’. The order may include a vector such as [x_{ord,1}, x_{ord,2}, x_{ord,3}] that may indicate the index of the target cell in the pre-configuration list. For instance, x_{ord,1}, x_{ord,2}, x_{ord,3}=‘000’ may point to the first cell on the target cell list, x_{ord,1}, x_{ord,2}, x_{ord,3}=‘001’ may point to the second cell in the list, and so on. In an example, the order type ‘010’ may be used, and the order bits may indicate the secondary serving cell.

In an embodiment, the order may indicate whether a simultaneous serving cell change should be performed. For example, when bit x_{ord,3} is set to 0, the WTRU may only perform a serving cell change of the primary cell or the secondary cell. When bit x_{ord,3} is set to 1 the WTRU may perform a simultaneous serving cell change. The target secondary serving cell may be determined according to the criteria described above. Bit x_{ord,1}, and bit x_{ord,2} may be reserved for future use.

In an embodiment, the order type for assisting serving cell change may correspond to an activation/deactivation order type used for multi-carrier operation. For example, a list that may include configured cells may be maintained. Each configured cell on each frequency may be numbered according to the received configuration. Each configured secondary cell and assisting cell may be assigned an index in the configuration list. An activation/deactivation order may indicate the index of the cell(s) to be activated and/or the index of the activated secondary or assisting cell(s) to be deactivated.

For example, two lists of cells may be maintained. One list may include secondary cells that may not be assisting cells, and one list may include assisting cells. The orders may correspond to the activation/deactivation order for multi-carrier operations, and the order may indicate an index to a cell in one of the lists. The WTRU determine which list the order corresponds to, based on the order sender. In one embodiment, the cell form which the order is received may indicate which list the WTRU should use. For example, if the order is received from an assisting cell then the UE uses the list of the assisting cells. If the order is received from a secondary cell, the WTRU may use the list of secondary cells. In an embodiment, the subframe timing of the order may be used to determine the list. For example, if the order is received in an odd subframe, the order may correspond to a secondary cell. If the order is received in an even subframe, the order may correspond to an assisting cell. In an embodiment, a new order type may correspond to assisting or preconfigured cells as described above, and the order bits may be used similar to the multi-carrier operation to activate/deactivate the cells.

If the WTRU receives an order to activate an assisting cell, and the number of activated assisting cells exceeds the maximum amount of allowed activated cells, the WTRU may not activate the cell. The WTRU may send a NACK to the network. The WTRU may trigger a report indicating that a configuration error has occurred. The network may not activate a cell without deactivated at least one secondary cell, if the total number of activated cells exceeds the maximum allowed secondary or assisting cells.

In an embodiment, the WTRU may use an order for the HS-DSCH serving cell change when one of the target cells is a current serving cell. For example, a target cell may correspond to the current primary serving cell, or may correspond to the current secondary serving cell. The WTRU may interpret the orders for activation and deactivation of discontinuous transmission (DTX), Discontinuous Reception (DRX) and HS-SCCH-less operation and for HS-DSCH serving cell change.

For example, an event 1D “change of best cell” may be triggered. The WTRU may receive DTX, DRX and HS-SCCH-less operation orders on the primary serving cell as long as timer T324 is running The WTRU may not interpret orders received on the secondary cell as DTX, DRX and HS-SCCH-less operation orders such that the WTRU may receive a HS-DSCH serving cell change order (x_{odt,1}, x_{odt,2}, x_{odt,3}=‘000’ and x_{ord,1}, x_{ord,2}, x_{ord,3}=‘000’) on the secondary serving cell.

For example, an event 1X “change of secondary best cell” may be triggered. The WTRU may receive DTX, DRX and HS-SCCH-less operation orders on the secondary serving cell as long as timer Txxx is running Timer Txxx may include the timer T324, or may include a new timer. The WTRU may not interpret orders received on the primary cell as DTX, DRX and HS-SCCH-less operation orders such that the WTRU may receive a HS-DSCH serving cell change order (x_{odt,1}, x_{odt,2}, x_{odt,3}=‘000’ and x_{ord,1}, x_{ord,2}, x_{ord,3}=‘000’) on the primary serving cell.

For example, when an event 1Y, “change of best primary and secondary best cells”, is triggered, or when both event 1D and event 1X are triggered, the WTRU may not interpret any order as DTX, DRX and HS-SCCH-less operation orders on any serving cell for a predetermined period of time. The predetermined period of time may be tracked using a timer such as timer T324 or a new timer. The WTRU may receive an HS-DSCH serving cell change order (x_{odt,1}, x_{odt,2}, x_{odt,3}=‘000’ and x_{ord,1}, x_{ord,2}, x_{ord,3}=‘000’) on the primary serving cell or on the secondary serving cell. In an embodiment, the WTRU may stop receiving DTX, DRX and HS-SCCH-less operation orders immediately after the WTRU sends the measurement. In an embodiment, the WTRU may continue to interpret DTX, DRX and HS-SCCH-less operation orders for a predetermined period time after sending the report. The value of the delay may be fixed or configurable by the network.

In an embodiment, when the target primary cell corresponds to the source secondary serving cell or the target secondary cell corresponds to the source primary serving cell, the WTRU may not perform enhanced serving cell change procedure. The WTRU may not monitor the HS-SCCH of the target cell. For example, the trigger to start monitoring the HS-SCCH of the target cell may determine whether the target cell is a source serving cell. The WTRU may start monitoring the HS-SCCH of the target cell based on a determination that the target cell is not a source serving cell.

In an embodiment, the multi-point transmission set or the cells may be managed via a MAC CE. The cells may be pre-configured or configured in the WTRU. Network based on RRC events, channel quality indicator (CQI) reports, or any other reports may assist the network in determining whether to change, activate, or deactivate an assisting or secondary serving cell. The WTRU may be directed to change the cells, activate cells or deactivate cell, for example, via MAC control signaling. The network can indicate the cell(s) to be activated/deactivated or added/removed from a multi-point set using a MAC CE.

In an embodiment, the WTRU may receive a serving cell switching order from a serving cell. The WTRU may make the current secondary serving cell the new primary serving cell, and may make the current primary serving cell the new secondary serving cell. In an embodiment, the serving cell switching order may be received on the current primary and secondary serving cells. In an embodiment, the serving cell switching order may be received on the current primary serving cell only. In an embodiment, the serving cell switching order may be received on the current secondary serving cell only.

For example, the cell switching order may or may not be triggered by a measurement event. The WTRU may expect to receive at any time a serving cell switching order. In an embodiment, the WTRU may expect to receive serving cell switching order when the WTRU has triggered a measurement event indicating a change of best cell, a change of best secondary cell or a change of both, and the new best cell corresponds to the current secondary serving cell and the new best secondary cell corresponds to the current primary serving cell.

Serving cells may be switched dynamically using a pre-configured target cell list. Target cells may also be referred to as candidate cells. The network may configure the WTRU for reporting the CQI of the pre-configured cells or a subset of the pre-configured cells. For example, the WTRU may be configured with a predetermined number of best pre-configured cells. For example, the WTRU may receive a subset of the pre-configured cells via a configuration message signaled by the network. RRC measurement events may be used by the network to determine which cells to activate and/or deactivate.

The WTRU may monitor the HS-SCCH of the cells for which the WTRU reports the CQI to the network. There may be a maximum number of non-serving cells that the WTRU may monitor the HS-SCCH from. In an embodiment, the network may send an order on one of the current serving cells, requesting the WTRU to monitor the HS-SCCH of one or more pre-configured target cells. The order may include an index pointing to a cell in the pre-configured target cell list, or any other indication of which cell(s) to monitor.

The WTRU may receive a serving cell change order via the HS-SCCH of a target assisting cell or from the primary serving cell. The serving cell change order may indicate that the sender cell is the new primary serving cell. The serving cell change order may indicate that the sender cell is the new secondary serving cell. In an embodiment, the serving cell change order may indicate that a serving cell change is to be performed. The WTRU may determine the type of the serving cell change, such as whether the serving cell change is a change of primary or secondary serving cell based on a preconfigured target cell list. The preconfigured target cell list may indicate whether each cell on the list may be a target primary cell or a target secondary cell.

In an embodiment, dynamically switching serving cells may be based on the CQI report for the serving cells. For example, the WTRU may send a list of CQIs of different cells in the HS-DPCCH. The WTRU may send the CQIs of different cells in a time division scheme in the HS-DPCCH. In an embodiment, High Speed Dedicated Physical Control Channel (HS-DPCCH) may be configured on the secondary serving cell and the primary serving cell. The WTRU may send CQIs on the secondary serving cell.

Activation and deactivation of cells may be handled at layer 1 level using CQI feedback and L1 orders. WTRU RRC may configure WTRU L1 with the candidate serving cells. A candidate serving cell may also be referred to as a target serving cell. The serving cells may be activated and/or deactivated based on the channel quality or based on information provided to the network as part of the measurement reports.

In an embodiment, serving cells may be dynamically activated and deactivated. WTRU layer 1 may be configured with a set of candidate serving cells. Candidate serving cells may be configured by the NodeB or by the network. For example, candidate serving cells may operate in the same frequency. Candidate serving cells may be used as HS-DSCH serving cells. Candidate serving cells may include the HS-DSCH active set described above. Candidate serving cells may be part of a network configured set of cells, which may include the DCH active set that the WTRU should perform CQI reporting but are not part of the multi-point set. Candidate serving cells may include serving cells that the network may activate or deactivate dynamically based on cell quality and/or measurement reporting.

The network may use L1 orders to explicitly handle the WTRU serving cell modifications. L1 orders may be defined for serving cell management. Existing HS-SCCH orders may be modified or reused by reinterpreting the orders when multipoint HSDPA is configured. For example, the primary cell may be activated or deactivated via L1 orders while the uplink frequency remains the same.

The network may provide predefined rules for triggering CQI monitoring and/or reporting of the candidate serving cells. The rules may involve one or more parameters such as cell specific offsets, absolute thresholds, scaling factors and/or timers, or the like. The parameters may be provided to the WTRU via broadcast messages such as System Information Blocks or any form of control or dedicated signaling.

The CQI of non-active candidate serving cell(s) may be identified at the network by predefined time location in HS-DPCCH where the CQI is being transmitted.

The WTRU may monitor the CQI of the candidate serving cells and may report the CQI to the network. Based on the CQI report, the network may activate one or more candidate serving cells for data reception. The WTRU may report the CQI of the active serving cells on a regular basis, for example every Transmission Time Interval (TTI). The WTRU may report the CQI of the non-active candidate serving cells if the CQI of a non-active candidate serving cell enters a predefined reporting range. The WTRU may report the CQI of the non-active candidate serving cells if the CQI of a non-active candidate serving cell reaches or exceeds a predetermined threshold. The WTRU may report the best non-active candidate serving cell periodically. The WTRU may report the CQI of non-active candidate serving cells at extended intervals, for example, long integer multiples of TTI.

In an embodiment, the WTRU may compare the CQI of the active serving cell values with the CQI of non-active candidate serving cell(s). The CQI of the non-active candidate serving cells may be reported when the CQI of a non-active candidate serving cell becomes better than the CQI of an active serving cell by a predefined value or by a predefined percentage. Based on the CQI report, the network may switch the active and non-active candidate serving cells. The NodeB may activate the non-active candidate serving cell and deactivate corresponding active serving cell.

In an embodiment, the network may deactivate active serving cells with CQI below a predefined threshold. For example, the WTRU may report the CQI of the active serving cells periodically. If the CQI of an active serving cell goes below a certain absolute value or a predefined threshold, the NodeB may send an L1 deactivation order to the WTRU. In an example, the active serving cell may be deactivated if the CQI of the active serving cell leaves a predefined reporting range.

In an embodiment, the WTRU's serving cells belong to a single NodeB and are co-located. The network may configure a NodeB with the information to operate multiple serving cells. The primary serving cell may be configured first, and the secondary serving cell may be configured on top of the primary serving cell. Both the primary and secondary serving cells may be configured simultaneously. Certain configuration parameters may be common to both primary and secondary serving cells, and the network may provide the non-common parameters to the NodeB to configure the secondary serving cell. The NodeB may obtain values for the common parameters from the primary serving cell configuration.

In an embodiment, the cells operating as serving cells for the WTRU may belong to different NodeBs. The network may configure a NodeB with an assisting cell on which a primary serving cell is not configured. The parameters unique to an assisting cell and parameters that may be common to both primary and secondary serving cells may be provided to the NodeB.

In an example HSDPA system, a WTRU may have primary and secondary serving HS-DSCH cells. The two cells may be co-located and may belong to the same NodeB. When an RNC needs to configure a NodeB with a secondary HS-DSCH serving cell, the RNC may provide the NodeB with cell configuration information via the HS-DSCH FDD Secondary Serving Information IE. For example, cell configuration information may include, but not limited to, HS-SCCH Power Offset, Measurement Power Offset, Sixty-four QAM Usage Allowed Indicator, HS-DSCH- Radio Network Temporary Identities (RNTI), MIMO Activation Indicator, Single Stream MIMO Activation Indicator, Diversity Mode, Transmit Diversity Indicator, Ordinal Number of Frequency.

Information for the NodeB to setup a secondary HS-DSCH serving cell may be obtained from the HS-DSCH FDD Information IE used to configure the primary serving cell. Configuration information related to MAC-d Flows, MAC-hs/ehs Information may be common between the primary and secondary serving cells. Such information may be provided to the NodeB once when the primary and the secondary serving cells belong to the same NodeB. When the primary and secondary serving cells may belong to different NodeBs, such information may be provided to the two NodeBs separately.

In an embodiment, the network may configure a NodeB to setup, update, modify, reconfigure or delete an assisting cell independently from a primary serving cell. When the network configures a NodeB or eNB with an assisting cell non-collocated with a primary serving cell, the network may the NodeB with the cell setup information. The cell setup information or a subset of the information may be exchanged and provided by the primary eNB or Node B. The cell setup information may include MAC layer specific information. MAC layer specific information may include, but not limited to, PDU size formats, guaranteed bit rate, MAC specific timers, MAC flow information, or the like. The cell setup information may include scrambling code information, HS-DPCCH information, physical layer parameters, CQI information, ACK/NACK information, relevant power offsets, DRX/DTX information, WTRU category, or the like. The cell setup information may include pre-configuration setup information that may be required for enhanced serving cell changes, HARQ specific information such as HARQ memory partitioning. The cell setup information may include Radio Link Control (RLC) information if the RLC is located in the Node B and the split is performed at the RLC level. The cell setup information may include PDCP information if the PDCP is located in the Node B and the split is performed at the PDCP level. The cell setup information may include security and ciphering information and keys.

The cell setup information may be provided to a NodeB via one or more IE(s). In addition to the existing IEs used for an assisting cell configuration, new IE(s) may defined to carry cell setup information. Existing IE(s) used to configure a collocated secondary serving cell may be modified to include the additional information needed to configure a non-collocated secondary serving cell. In an embodiment, new IE(s) may be introduced to carry the parameters for configuring a non-collocated secondary multi-point serving cell.

In an example HSPA system, an RNC may configure a NodeB with an assisting HS-DSCH cell without a primary serving HS-DSCH cell. Configuration parameters may be provided to the NodeB. Configuration parameters may include, but not limited to, HS-DSCH MAC-d flows information, HS-DSCH physical layer category, scrambling code of the WTRU for decoding the feedback information transmitted by the WTRU, HS-DPCCH information, MAC-hs/ehs information, CQI information, ACK/NACK information, Measurement Power Offset, HS-DSCH-RNTI, DRX/DTX information, or the like. Configuration parameters may include information such as HS-SCCH Power Offset and HS-DSCH MAC-d PDU Size Format.

In an embodiment, the HS-DSCH FDD Secondary Serving Information IE may be extended to include the above mentioned configuration parameters. A new IE, for example, HS-DSCH FDD non-collocated Secondary Serving Information IE, may include the above-mentioned configuration parameters.

The Radio Link Setup Request message may include the configuration for establishing an assisting HS-DSCH radio link. Physical Shared Channel Reconfiguration Request message may be used to assign secondary serving HS-DSCH related resources to a NodeB. Radio Link Addition Request message may be used to establish the necessary resources in the NodeB for a secondary serving HS-DSCH radio link (RL) towards a WTRU when there is already a NodeB communication context for this WTRU in the NodeB.

Synchronized/Unsynchronized Radio Link Reconfiguration Preparation Request message may be used to prepare new configuration of radio links related to NodeB communication context. The Synchronized/Unsynchronized Radio Link Reconfiguration Preparation Request message may include information associated with Secondary Serving HS-DSCH setup, Intra-NodeB Secondary Serving HS-DSCH Radio Link Change, Secondary Serving HS-DSCH Modification, Secondary Serving HS-DSCH Removal, or the like. Radio Link Parameter Update message may be used when an update of secondary serving HS-DSCH related radio link parameter values are needed on the NodeB side

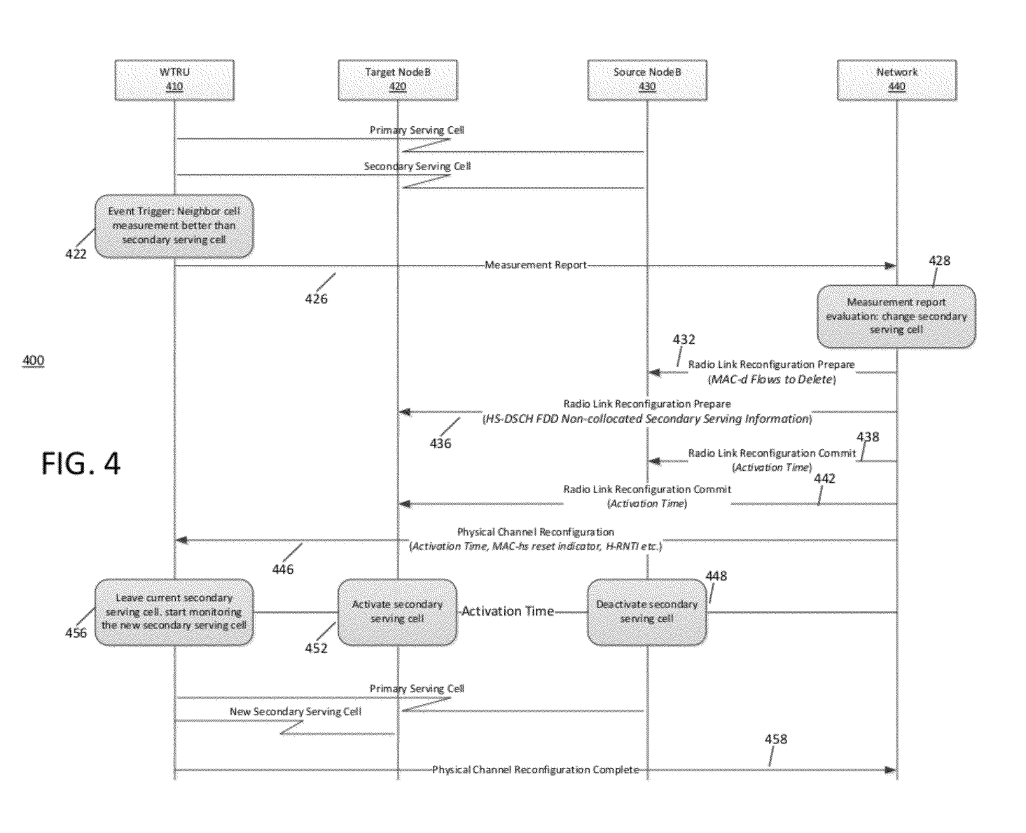

FIG. 4 illustrates a diagram of a synchronized radio link reconfiguration prepare procedure. As shown, WTRU 410 may be a WTRU 102 described with respect to FIGS. 1A-1E. WTRU 410 may operate in network 440 that may include a core network 106 described with respect to FIGS. 1A, and 1C-1E. As shown, the WTRU 410 may be configured with a primary serving cell and an assisting cell in the same NodeB such as the source NodeB 430.

For example, an assisting cell of the WTRU 410 may change from a serving cell in the source NodeB 430 to an assisting cell in another NodeB such as target NodeB 420. At 422, the WTRU may detect that a neighbor cell measurement becomes better than the assisting serving cell measurement. For example, the WTRU 410 may detect that the quality of a serving cell in target NodeB 420 may exceed the quality of a serving cell in source NodeB 430. An event such as a cell replacement event described above may be triggered. At 426, the WTRU 410 may send a measurement report to the network 440. The measurement report may include the measurements of the serving cells. At 428, the network may evaluate the measurement report, and may determine that the secondary serving cell of the WTRU 410 is to be changed.

The network may prepare the source NodeB 430 and the target NodeB 420 for the serving cell change. The target NodeB may receive information for configuring a non-collocated secondary serving cell. Referring to FIG. 4, at 432, the network may send a message such as a Radio Link Reconfiguration Prepare message to the source NodeB 430. The Radio Link Reconfiguration Prepare message may indicate that a MAC-d flow is to be deleted. At 436, the network may send a message such as a Radio Link Reconfiguration Prepare message to the source NodeB 430. The Radio Link Reconfiguration Prepare message may include the HS-DSCH FDD Non-collocated Secondary Serving Information IE described above. At 438, the network may send a Radio Link Reconfiguration Commit message to the source NodeB 430, which may indicate an activation time of the secondary serving cell in the target NodeB 420. The Radio Link Reconfiguration Commit message may indicate a deactivation time of the secondary serving cell in the source NodeB 430. At 442, the network may send a Radio Link Reconfiguration Commit message to the target NodeB 420, which may indicate an activation time of the secondary serving cell in the target NodeB 420.

At 446, the network 440 may prepare the WTRU 410 for the serving cell change. The WTRU 410 may receive a Physical Channel Reconfiguration message from the network. The Physical Channel Reconfiguration message may include, but not limited to, an activation time of the secondary serving cell in the in the target NodeB 420, a MAC-hs reset indicator, an H-RNTI indicator, and/or the like. At 448, the source NodeB 430 may deactivate the secondary serving cell based on the activation time or deactivation time received from the network. At 452, the target NodeB 420 may activate the secondary serving cell based on the activation time received from the network. At 456, the WTRU 410 may leave the current secondary serving cell in the source NodeB 430, and may start monitoring the new secondary serving cell in the target NodeB 420. As shown, the WTRU 410 may be configured with a primary serving cell in one NodeB such as the source NodeB 430, and an assisting cell in another NodeB such as the target NodeB 420. At 458, the physical channel reconfiguration may be completed. The WTRU 410 may send a message to the network to indicate that the physical channel reconfiguration is completed.

Though the embodiments are described herein for multi-point configuration in a single frequency or in multiple frequencies with a possibility to configure two serving cells, it is understood that the embodiments can be extended to configurations with more than two serving cells. The embodiments disclosed herein apply to all multi-cell configurations and are not restricted to dual-cell configuration or single-frequency configurations.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for receiving data from a plurality of cells in a wireless communication network, the method comprising:
receiving data from a plurality cells in a multi-point set, the multipoint set comprising a primary serving cell and an assisting serving cell;
triggering a reporting event based on a cell quality of at least one of the primary serving cell, the assisting serving cell, or a non-assisting cell;
receiving an indication of a change to the multi-point set; and
modifying the multi-point set based on the indication.

2. The method of claim 1, further comprising:
sending a measurement report to the wireless communication network, the measurement report comprising an indication of the reporting event and the cell quality associated with the primary serving cell, the assisting serving cell, and the non-assisting cell.

3. The method of claim 1, wherein the reporting event comprising a cell adding event, and the cell adding event is triggered when the non-assisting cell enters a reporting range.

4. The method of claim 1, wherein the reporting event comprises a cell adding event, and the cell adding event is triggered when the cell quality of the non-assisting cell exceeds a predetermined threshold.

5. The method of claim 1, wherein the reporting event comprises a cell removing event, and the cell removing event is triggered when the cell quality of the assisting cell is below a predetermined threshold.

6. The method of claim 1, wherein the reporting event comprises a cell removing event, and the cell removing event is triggered when the assisting cell leaves a reporting range.

7. The method of claim 1, wherein the reporting event comprising a cell replacement event, the cell replacement event is triggered when the cell quality of the non-assisting cell exceeds the cell quality of the assisting cell for a predetermined period of time.

8. A method for receiving data from a plurality of serving cells in a wireless communication network, the method comprising:
receiving, at a wireless receive and transmit unit (WTRU), pre-configuration information associated with a plurality of target cells;
receiving a first indication from the wireless communication network to activate a first target cell;
connecting to the first target cell based on the pre-configuration information associated with the first target cell; and
receiving data via the first target assisting cell.

9. The method of claim 8, further comprising:
receiving a second indication from the network to deactivate the first target cell; and
stop receiving data via the first target cell.

10. The method of claim 8, further comprising:
receiving a second indication from the network to activate a second target cell of the plurality of target cells as a second assisting serving cell; and
starting to receive data via the second target cell.

11. The method of claim 8, wherein the first indication comprises at least one of a layer 1 order, a layer 2 order, a medium access control (MAC) control element, or a physical downlink control channel (PDCCH) order.

12. A wireless transmit and receive unit (WTRU) configured to receive data from a plurality of serving cells in a wireless communication network, the WTRU comprising:
a transceiver configured to:
receive pre-configuration information associated with a target cell list, the target cell list comprising the plurality of target cells, and
receive data via at least one of the plurality of target cells;
a memory configured to:
store the pre-configuration information associated with the target cell list; and
a processor configured to:
determine that a first cell has been added to an active set associated with the WTRU, and
add the first cell to the target cell list.

13. The WTRU of claim 12, wherein the transceiver is further configured to receive pre-configuration information associated with the first cell, and the memory is further configured to store the pre-configuration information associated the first cell.

14. The WTRU of claim 12, wherein the processor is further configured to:
determine that a second cell on the target cell list has been removed from an active set associated with the WTRU;
remove the second cell from the target cell list; and
delete pre-configuration information associated the second cell.

15. A wireless transmit and receive unit (WTRU) configured to receive data from a plurality of serving cells in a wireless communication network, the WTRU comprising:
a transceiver configured to:
receive data from a primary serving cell and an assisting serving cell;
a memory configured to:
store a target cell list comprising a plurality of target cells, and
store pre-configuration information associated each of target cells;
a processor configured to:
trigger a reporting event based on the cell quality of at least one of the target cells, the primary serving or the assisting serving cell; and
the transceiver further configured to:
receive a serving cell change order indicating a change of at least one of the primary serving cell or the assisting cell.

16. The WTRU of claim 15, wherein the order indicates the assisting cell is to be changed to a first target cell on the target cell list, and
the processor is further configured to:
connect to the first target cell based on the pre-configuration information associated with the first target cell, and
the transceiver is further configured to:
receive data from the first target cell and the primary cell.

17. The WTRU of claim 15, wherein the order indicates the primary cell is to be changed to a first target cell on the target cell list, and
the processor is further configured to:
connect to the first target cell based on the pre-configuration information associated with the first target cell, and
the transceiver is further configured to:
stop receiving data from the primary serving cell, and
receive data from the first target cell and the assisting serving cell.

18. The WTRU of claim 17, wherein the processor is further configured to monitor a target cell that triggered the reporting event for serving cell change orders for a predetermined period of time.

19. The WTRU of claim 15, wherein the transceiver is further configured to:
send the channel quality indicator report for at least one of the target cell on the target cell list, and
the processor is further configured to:
monitor a channel of the at least one target cell for serving cell change orders, wherein the serving cell change order is generated based on the channel quality indicator report, wherein the serving cell change order is received via the at least one target cell, and the at least one target cell.

20. The WTRU of claim 15, wherein the reporting event includes a cell swapping event, and the reporting event is triggered when the cell quality of the assisting serving cell exceeds the cell quality of the primary serving cell by a predetermined value, and wherein the cell change order indicates a swap of the primary serving cell and the assisting serving cell.
